(19) United States
(12) Patent Application Publication
(10) Pub. No.: US 2026/0102232 A1
(43) Pub. Date: Apr. 16, 2026

(54) SiCN LAYERS AND METHODS OF MAKING SiCN LAYERS

(71) Applicant: University of Florida Research Foundation, Inc., Gainesville, FL (US)

(72) Inventors: Josephine F. Esquivel-Upshaw, Gainesville, FL (US); Fan Ren, Gainesville, FL (US)

(21) Appl. No.: 19/226,275

(22) Filed: Jun. 3, 2025

Related U.S. Application Data
(60) Provisional application No. 63/655,631, filed on Jun. 4, 2024.

(51) Int. Cl. A61C 13/09; C23C 16/36; C23C 16/505; C23C 16/56

(52) U.S. Cl. CPC A61C 13/09; C23C 16/36; C23C 16/505; C23C 16/56

(57) ABSTRACT

The present disclosure provides for making silicon carbonitride (SiCN) layers or a quaternized SiCN layers on a structure and medical apparatus including the structure having the SiCN layer or a QSiCN layer. The presence of the SiCN layer or a QSiCN layer on the substrate give the substrate one or more of following characteristics: anti-bacterial, osseointegrative and anti-corrosive.

### CROSS-REFERENCE TO RELATED APPLICATIONS

This application claims the benefit of: U.S. Provisional Patent Application No. 63/655,631 filed on Jun. 4, 2024, which is incorporated herein by reference in its entirety.

### FEDERAL FUNDING

This invention was made with government support under Grant No. R56 DE025001 awarded by The National Institutes of Health. The government has certain rights in the invention.

### BACKGROUND

Peri-implantitis is defined as mucosal inflammation and deep pocketing surrounding the implant along with 2 mm or more of alveolar bone resorption after implant loading, whereas peri-mucositis includes of mucosal inflammation without the bone resorption. Although there are many unknowns with regards to disease initiation and treatment for peri-implantitis, bacteria are the major causative factor in proliferation of the disease. Peri-implantitis can eventually lead to loss of the implant and the prosthesis being supported with continued progression. Thus there is a need to address peri-implantitis by modifying the implant material to decrease the proliferation of bacteria around the implant.

### SUMMARY

The present disclosure provides for making silicon carbonitride (SiCN) layers or a quaternized SiCN layers on a structure and medical apparatus including the structure having the SiCN layer or a QSiCN layer. The presence of the SiCN layer or a QSiCN layer on the substrate give the substrate one or more of following characteristics: anti-bacterial, osseointegrative and anti-corrosive.

The present disclosure provides for a medical apparatus, comprising a structure having a silicon carbonitride (SiCN) layer or a quaternized SiCN layer on the outside surface of the structure.

The present disclosure provides for a method for forming a silicon carbonitride (SiCN) layer on an apparatus, comprising: mixing NH₃ gas, SiH₄ gas, and CH₄ gas in a chamber, wherein the chamber includes the apparatus, and forming a silicon carbonitride (SiCN) layer on a structure of the apparatus.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1.1A-G illustrates SEM images of the surface of (FIG. 1.1A) Si, (FIG. 1.1B) SiC, (FIG. 1.1C) SiCN, and QSiCN with (FIG. 1.1D) 5%, (FIG. 1.1E) 10% and (FIG. 1.1F) 15% nitrogen content. FIG. 1.1G illustrates image with a larger magnification image of QSiCN with 5% nitrogen content. Note yellow arrow pointing to the ring-shaped pattern and red arrow pointing to irregular outline of bacterial cell.

FIG. 1.2 illustrates osteoblast growth after 3 days of incubation. Note higher osteoblast growth for QSiCN coated group.

FIG. 1.3 illustrates osteoblast adhered to QSiCN coated nanotube surface (inset, white arrow). Note filipodia (arrow) emanating from osteoblast, indicating attachment.

FIG. 1.4A illustrates biopsy sample of peri-implantitis tissue showing evidence of Ti particles (yellow arrows) embedded in soft tissue and FIG. 1.4B illustrates SEM analysis of biopsy sample showing Ti particle (red circle) which was confirmed by EDS.

FIGS. 1.5A-B illustrates SEM images of (FIG. 1.5A) reference implant and (FIG. 1.5B) failed implant on the right. Note increased roughened surfaces and increased corrosive landmarks on the failed implant (red circle).

FIGS. 1.6A-B illustrates non-coated (FIG. 1.6A) and coated (FIG. 1.6B) sample after 30 days P. gingivalis inoculation. Compare with FIG. 1.4A, non-coated reference image and note broken ridges (yellow arrows) on top of the nanotubes for the uncoated sample.

FIG. 1.7 illustrates improved osseointegration potential from QSiCN coating because of positive surface on TiO₂ that attracts osteoblasts

FIG. 1.8 illustrates anti-bacterial property of QSiCN through lipid peroxidation of bacterial membrane leading to cell apoptosis with leaching of cytoplasmic material.

FIG. 2.1 illustrates the deposition rate of N atom percentage for SiCN film with varying NH₃ flow rates.

FIG. 2.2 illustrates XPS survey scans of SiCN film deposited with 300 sccm SiH₄, 4 sccm NH₃, and 100 sccm CH₄.

FIGS. 2.3A-C illustrate deconvoluted high-resolution XPS spectra of A) Si2p, B) C1s (decovoluted into two peaks, C—Si, C—C or C—H, and C) N1s core-Ivel peaks (deconvoluted into two peaks, Si—N and SiC for SiCN deposited with different NH₃ flow rates.

FIGS. 2.4A-C illustrate deconvoluted high-resolution XPS spectra of A) Si2p, B) C1s (decovoluted into two peaks, C—Si, C—C or C—H, and C) N1s core-Ivel peaks (deconvoluted into two peaks, Si—N and SiC for SiCN deposited with different CH₄ flow rates.

FIGS. 2.5A-C illustrate deconvoluted high-resolution XPS spectra of A) Si2p, B) C1s (decovoluted into two peaks, C—Si, C—C or C—H, and C) N1s core-Ivel peaks (deconvoluted into two peaks, Si—N and SiC for SiCN deposited with different SiH₄ flow rates.

FIG. 2.6 illustrates refractive indices of SiCN films deposited with various NH₃ flow rates.

FIG. 2.7 illustrates contact angles of SiCN films deposited with various NH₃ flow rates.

FIG. 2.8 illustrates corrosion rates of SiCN films deposited with varying NH₃ flow rates in solutions with pH values of 2, 7, and 10.

FIG. 3.1 illustrates schematic drawings of sample testing configurations for bacterial culture.

FIGS. 3.2A and B illustrate contact angle images of A) Si and B) QSiCN surface with 5% nitrogen content.

FIGS. 3.3A-3.3C illustrate high-resolution XPS spectra of N1 peak analysis of SiCN surfaces with A) 0°-and B) 45°-tilted coating surfaces and C) the peak separation of 45°-tilted QSiCN spectra.

FIG. 3.4 illustrates colony-forming unit (CFU) per milliliter of S. mutan culture on Si, SiC, SiCN, and QSiCN substrates with different nitrogen contents after 24 and 48 hours of incubation time.

FIGS. 3.5A-3.5H illustrate fluorescence microscopy images of S. mutans cultured for three days on QSiCN surface with A) 5%, B) 10%, and C) 15% nitrogen content and D) Si as the control group; and seven days culture time on SiCN surface with E) 55, F) 10%, and G) 15% nitrogen content and h) Si as the control group.

FIG. 3.6 illustrates the optimization of nitrogen concentration range in QSiCN using Pearson IV and Edgeworth-Cramer Peak Function.

FIGS. 3.7A-3.7G illustrates SEM images of the surface of A) Si, B) SiC, C) SiCN, and QSiCN with D) 5%, E) 10%, and F) 15% nitrogen content. FIG. 7G illustrates a larger magnification image of quaternized SiCN, with 5% nitrogen content. Note left hand arrow is pointing to the ring-shaped pattern and the right arrow is pointing to irregular outline of bacterial cell.

### DETAILED DESCRIPTION

The present disclosure provides for making silicon carbonitride (SiCN) layers or a QSiCN layers on a structure and medical apparatus including the structure. Before the present disclosure is described in greater detail, it is to be understood that this disclosure is not limited to particular aspects described, and as such may, of course, vary. It is also to be understood that the terminology used herein is for the purpose of describing particular aspects only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual aspects described and illustrated herein has discrete components and features which may be readily separated from or combined with the features of any of the other several aspects without departing from the scope or spirit of the present disclosure. Any recited method can be carried out in the order of events recited or in any other order that is logically possible.

Aspects of the present disclosure will employ, unless otherwise indicated, techniques of chemistry, biology, and the like, which are within the skill of the art.

Before the aspects of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular aspects only, and is not intended to be limiting. It is also possible in the present disclosure that steps can be executed in different sequence where this is logically possible.

### Definition

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “an implant,” “a layer,” or “a biofilm,” includes, but is not limited to, two or more such implants, layers, or biofilms, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material. For example, an “effective amount” of a SiCN layer or QSiCN layer refers to an amount that is sufficient to achieve the desired improvement in the property modulated by the formulation component, e.g. achieving the one or more of the following characteristics: anti-bacterial, osseointegrative and anti-corrosive. The specific level in terms of SiCN layer or QSiCN layer in a composition required as an effective amount will depend upon a variety of factors including the amount and type of modifying agent used, thickness of a SiCN layer or QSiCN layer, implant type, and end use of the article made using the composition.

As used herein, the terms “allylic halide” or “allyl halide” refers to an alkyl halide in wherein a carbon atom next to a double bonded carbon atom comprises one or more halogen atoms.

### DISCUSSION

The present disclosure provides for making silicon carbonitride (SiCN) layers or a quaternized SiCN layers on a structure and medical apparatus including the structure having the SiCN layer or a QSiCN layer. The presence of the SiCN layer or a QSiCN layer on the substrate give the substrate one or more of following characteristics: anti-bacterial, osseointegrative and anti-corrosive. In an aspect, the SiCN layer or a QSiCN layer give the substrate an increased positive charge (e.g., N⁺) as compared to other substrates such as dental implants. Additional details are provided in the Examples.

In an aspect, the present disclosure provides for medical apparatus that includes a structure that has a silicon carbonitride (SiCN) layer or a QSiCN layer on the outside surface of the structure. In particular, an effective amount of the SiCN layer or a QSiCN layer is used to give the substrate one or more of following characteristics: anti-bacterial, osseointegrative and anti-corrosive. The “outside surface of the structure” refers to a surface of the structure of the medical apparatus that exposed to the environment that it present in. For example, if the medical apparatus is a dental implant, then the outside surface of the structure is exposed to the environment in the mouth (e.g., saliva, bodily fluids, food, beverage, air, bacteria, and the like).

The medical apparatus can include a dental component such as a dental implant, crown, bridge, filling, veneer, inlay, onlay, endodontic device, or orthodontic bracket. In a particular aspect, the dental component is a dental implant. The dental component can be made of a material such as porcelain, ceramic, resin, metal, alloy, plastic, or a combination thereof. In an aspect, the porcelain is a porcelain layer that is part of a veneer for a tooth. In an aspect, the SiCN layer or a QSiCN layer can be disposed on the surface of the structure so that the SiCN layer or a QSiCN layer is on the outside surface of the structure. In an aspect, the dental component can include one or more layers of a material such as metal or alloy (e.g., titanium, titanium oxide, or titanium nitride), upon which the SiCN layer or a QSiCN layer is disposed so that the SiCN layer or a QSiCN layer is on the outside surface of the structure. In aspects that include a layer of titanium, titanium oxide, or titanium nitride, the layer can have a thickness of about 50 Å to 1000 Å.

In an aspect, the SiCN layer or a QSiCN layer can have a thickness about 5-30 nm, about 10-20 nm, or about 12-18 nm. The SiCN layer can be formed using a deposition process such as plasma-enhanced chemical vapor deposition (PECVD). Once the SiCN layer is formed, the SiCN layer can be quaternized so to form N⁺ moieties in the SiCN layer using a quaternizing technique such as a Menschutkin reaction. In an aspect, the QSiCN layer can have a nitrogen content of about 0.05% to 15%, about 0.05%, about 10%, or about 15%.

In an aspect, the QSiCN layer can have a Sessile contact angle of greater than 85° or about 85° to 92°.

The present disclosure also provides for a method of making a SiCN layer on an apparatus. In general, NH₃ gas, SiH₄ gas, and CH₄ gas can be mixed in a reaction chamber that includes the structure of the apparatus (e.g. dental component). Under certain conditions for a certain time frame (e.g., about 1 min to 60 min, or longer), a SiCN layer (e.g., a thickness about 5-30 nm, about 10-20 nm, or about 12-18 nm) is formed on a structure of the apparatus. The optimal conditions (e.g., temperature, pressure) can vary based on the deposition process used. When the deposition process is plasma-enhanced chemical vapor deposition (PECVD), the pressure can be about 0.01 to 1 millibars or about 0.1 to 0.5 millibars and the temperature can be about 150 to 500° C. or about 200 to 400° C. In an aspect, the NH₃ flow rates is about 2 to 8 sccm, wherein the SiH₄ flow rates of 200 to 300 sccm, and wherein the CH₄ flow rate is about 100 to 200 sccm. The flow rates of each component can be varied to general the desired SiCN.

In an aspect, the SiCN layer can be quaternized to form a QSiCN layer having a nitrogen content of about 5 to 15%, about 5%, about 10%, or about 15%. In an aspect, quaternizing involves reacting the SICN layer with an alkylating agent, e.g., an alkyl halide to quaternize the SICN. For example, in some aspects the alkylating agent can be an allyl halide, (e.g., an allyl chloride, allyl bromide or allyl iodine) (e.g., allyl group can be C1 to C6 carbon chain or C1 to C3 carbon chain so that C1-C6 alkyl halide can be used). In various aspects, the quaternization of nitrogen moieties in the titanium nitride layer comprises a Menschutkin reaction utilizing the alkylating agent. In an aspect, the alkyl halide is a quaternary ammonium moiety.

In an aspect, prior to forming the SiCN layer on the structure, one or more layers of other materials can be disposed on the structure. For example, a metal or metal alloy layer can be disposed on the structure and then the SiCN layer on the structure, where the SiCN layer on the structure is on the outside surface of the structure. As a result, the methods provided above and herein can include an addition step(s) to form the one or more layers and then the SiCN layer is formed. Subsequently, the SiCN layer can be quaternized.

In various aspects, the SiCN layer or a QSiCN layer can be antibacterial to provide resistance to bacterial or microbial growth on the apparatus (e.g., a dental implant). For example, the QSiCN layer reduce biofilm formation by at least 10% compared to a compositionally similar SiCN layer that is not modified by the disclosed methods to comprise a QSiCN layer, in particular the reduction in biofilm is observable within four hours using the methods disclosed herein. In a still further aspect, the reduction in biofilm formation on a QSiCN layer compared to a compositionally similar SiCN layer that is not modified using the disclosed is a reduction within about four hours of about 10%, about 15%, about 20%, about 25%, about 30%, about 35%, about 40%, about 45%, about 50%, about 55%, about 60%, about 65%, about 70%, about 75%; or any range encompassed by the foregoing values (e.g., about 10 to 75%, about 20 to 45%, about 30 to 70% and so on); or any combination of the foregoing values.

The antibacterial efficiency of the QSiCN layer can be tested through standard methodology, e.g., ISO 22196 for the measurement of antibacterial activity on a surface. Confirmation of surface chemistry change conferred using the disclosed methods can be assessed via Sessile drop contact angle and X-Ray Photoelectron Spectroscopy.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1

### QSiCN and SiCN

The addition of nitrogen to dielectric silicon carbide thin film, has enhanced the properties of this material to become anti-bacterial, osseointegrative and anti-corrosive. Quaternization adds an additional nitrogen ion that imparts improved anti-bacterial properties to the coating.

Thin films for dental coatings were initiated by our group to improve fracture resistance and wear of dental ceramic restorations. Silicon Carbide (SiC) was found to be the most ideal material as this coating prevented the dissolution or wear of the ceramic material. The effect of SiC as an anti-bacterial coating was explored after discovering that this coating minimized bacterial growth on ceramics. This SiC was applied to dental implants due to the prevalence of peri-implantitis.

Peri-implantitis is defined as mucosal inflammation and deep pocketing surrounding the implant along with 2 mm or more of alveolar bone resorption after implant loading, whereas peri-mucositis consists of mucosal inflammation without the bone resorption. Peri-implantitis prevalence can be anywhere from 1.1% to 85% [1], owing partially to a lack of standardized criteria for diagnosis. A nationwide Swedish study [2] determined the prevalence of the disease to be 45% after 10 years. Although there are many unknowns with regards to disease initiation and treatment for peri-implantitis, bacteria are the major causative factor in proliferation of the disease. This disease has been associated with aggressive and resistant microbes with higher counts of several bacterial species such as Porphyromonas gingivalis, Prevotella intermedia, P. nigrescens, Treponema denticola, Fusobacterium nucleatum, Aggregatibacter actinomycetemcomitans, and Tannerella forsythia [3]. In addition, peri-implantitis microbiota has also seen a proliferation of opportunistic pathogens, fungus, Cytomegalovirus (CMV), and Epstein-Barr (EB) viruses [4]. Arresting progression of the disease once the disease initiates is difficult and therapies, in the form of antibiotics or standard periodontal therapy, have a high recurrence rate within two years [5]. The most effective treatment so far is prevention by minimizing microbial colonization, preventing corrosion of the implant surface with degradation of the oxide layer, and implementing implant maintenance regimens in the form of yearly check-ups and periodic implant cleanings [6]. From a materials aspect, titanium (Ti) corrosion has been shown to initiate inflammatory reactions [7, 8] and could contribute to the progression of peri-implantitis. Clinically, peri-implantitis presents as bleeding on probing, redness, edema, and increased pocket depths with or without suppuration [9-11]. Histological findings confirm the presence of larger lesions compared with periodontal disease lesions and have an overabundance of inflammatory cells such as neutrophils, macrophages, and plasma cells [9]. In addition, TNF-α and IL-1β, a dominant osteoclast activating cytokine, were abundant in peri-implantitis sites [12]. The pathogenesis of this disease is theorized to be an initiating reaction which leads to a shift in increased pathogenic bacteria, which in turn leads to an activation of an inflammatory mechanism. This mechanism cascades into a vicious cycle of bone loss, titanium corrosion from decreased environmental pH and progression of inflammation. Peri-implantitis can eventually lead to loss of the implant and the prosthesis being supported with continued progression.

### A. Anti-Bacterial

A SiCN film was developed using a PECVD (Plasma Enhanced Chemical Vapor Deposition) process and examined the impact of varying NH₃, CH₄, and SiH₄ flow rates on the chemical composition, antibacterial properties, refractive index, wettability, and corrosion rate of SiCN films [13]. The results demonstrated that the deposition rate of SiCN films increased with increasing NH₃ flow rate, and the resulting films had a nanometer-scale thickness that enables fine control over the film thickness for thin film applications. NH₃ flow rate was found to play a significant role in the formation of N—Si bonds, which may contribute to the antibacterial properties of SiCN films by creating a positively charged surface that can interact with bacterial cell membranes. This positively charged N⁺ atom can interact with negatively charged sites on bacterial cell membranes, leading to membrane disruption and cellular damage [14-19]. Additionally, SiCN films can generate reactive oxygen species (ROS) upon exposure to light or heat, which can further damage bacterial cells [20, 21]. SiCN films with higher N⁺ content, resulting from increased NH₃ flow, exhibited lower refractive indices. A high N⁺ may make the coating more brittle and prone to cracking or chipping [22], which can compromise performance and durability of the material. Therefore, determining the ideal N⁺ content for anti-bacterial properties is important to attain a balance between bactericidal and mechanical properties required. The SiCN films in this study were found to have a relatively small change in contact angle and may contribute to reducing bacteria attachment.

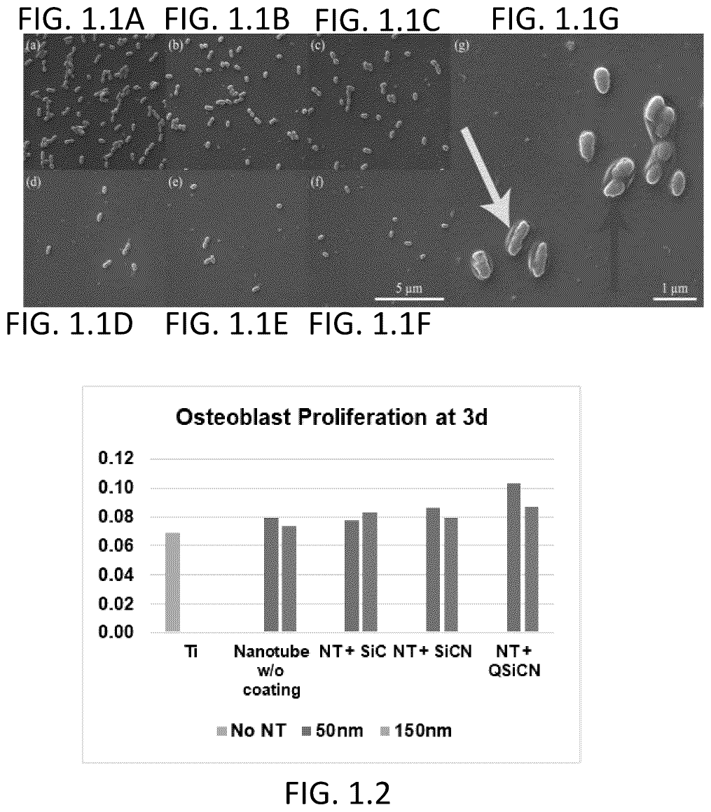

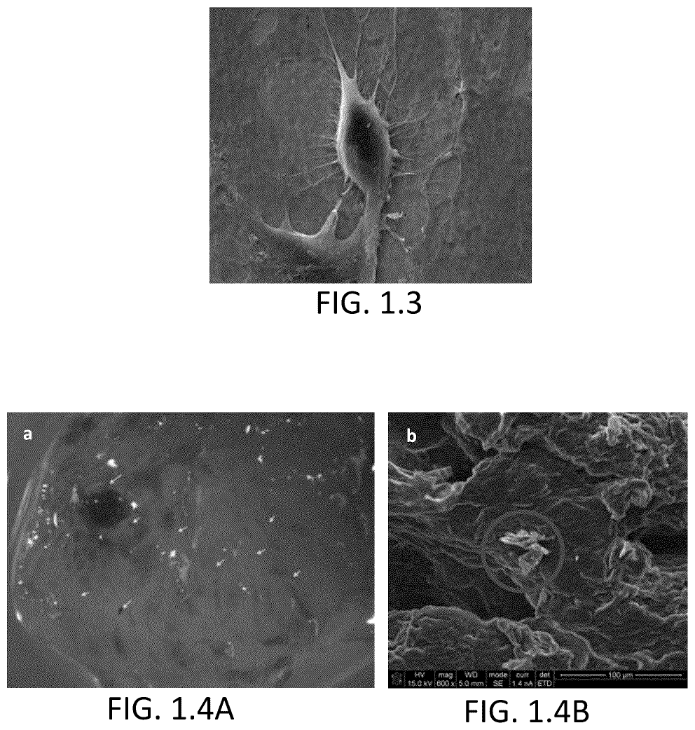

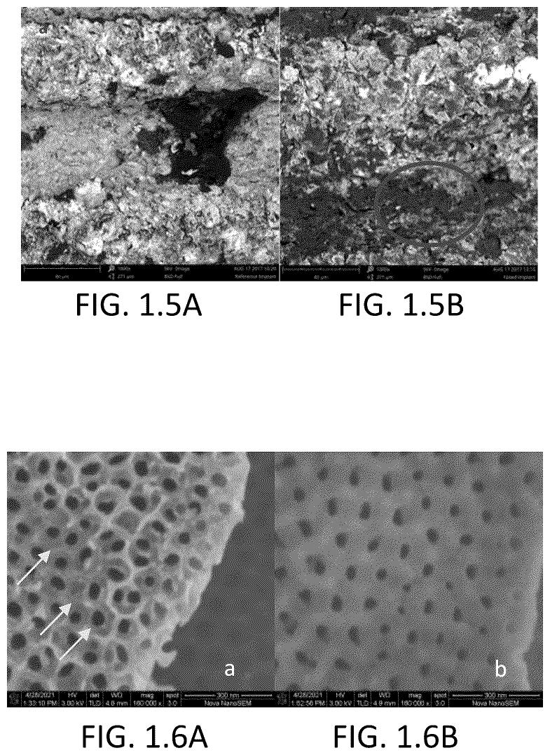

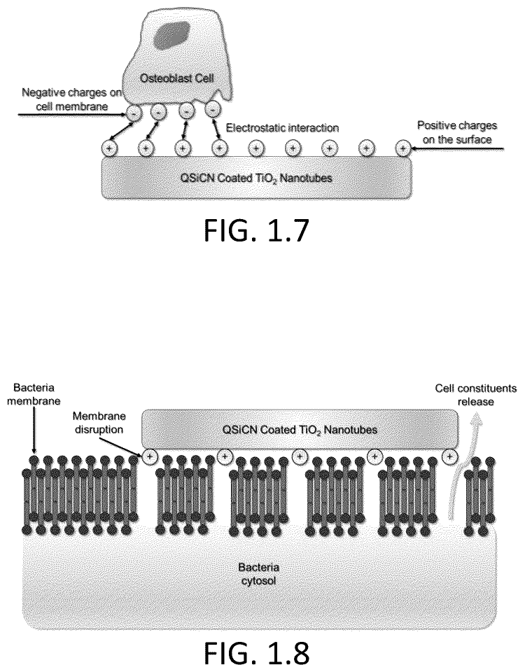

The SiCN film was further advanced to develop Quaternized Silicon Carbon Nitride (QSiCN) [13, 23]. Quaternization allows the addition of an extra N⁺ ion that further enhances anti-bacterial properties. The quaternization process increases the hydrophobicity as evidenced by contact angle measurements. The hydrophobicity is attributed to the presence of extended allyl group chains originating from the surface, resulting from the Menshutkin reaction that converts tertiary nitrogen atoms into quaternary nitrogen atoms. The antibacterial properties of Si, SiC, SiCN and QSiCN were compared in the experiment. The optimal N % content for anti-bacterial properties was determined by incorporating 5, 10 and 15% N in the quaternization process. Bacterial coverage on non-quaternized surfaces of Si, SiC, and SiCN (FIG. 1.1A-C) demonstrates significantly more bacteria compared to the quaternized surfaces (FIG. 1.1D-F). At higher magnification, (FIG. 1.1G), SEM image of the 5% nitrogen-containing QSiCN surface revealed a ring-shaped pattern in the surrounding area, along with an irregular outline of the bacterial cell, indicating ruptures in the bacterial membrane. This suggests that the bacterial cells on the QSiCN surface underwent membrane damage, leading to cell termination on the surface of the substrate [24-26]. This finding provides valuable insight into the potential mechanism underlying the enhanced antibacterial effect of the QSiCN surfaces.

### Osseointegrative

Aside from excellent anti-bacterial properties, QSiCN was also found to have osseointegrative potential resulting from the positive surface charge produced by the extra Nitrogen ion. Studies were conducted on human osteoblast (Nhost, Lonza, USA) adhesion and proliferation [27, 28] on coated Ti disks (SiC and QSiC) with 100 nm nanotubes cultivated for 24h confirm that the coatings do not inhibit attachment of bone forming cells with similar results to the uncoated control group (p=0.1589). No obvious cytotoxicity was observed as evidenced on osteoblasts by the absorbance of the cells cultured on coatings being comparable to the control group. The mineralization potential of anodized and coated SiC Ti disks was determine as well as the optimal nanotube diameter for osteoblast growth by comparing 50 nm and 100 nm coated nanotubes [29]. After 21 days of induced osteogenic differentiation, there was significantly higher osteoblast calcification on coated groups of both diameters when compared with non-coated groups (p<0.05). Based on these results, it can be concluded that the SiC contributed to an increase in osteoblast mineralization, was biocompatible and non-cytotoxic. The Ti nanotube diameter did not play a role on cell viability or mineralization of pre-osteoblasts on SiC-coated or non-coated anodized Ti samples. The rationale for this increased mineralization for SiC coated groups is the method of preparation, which incorporated a monolayer of N+ to the surface. A similar test was conducted for osteoblast growth using QSiCN coated 50 nm and 150 nm nanotubes. Results demonstrated that QSiCN had significantly higher osteoblast proliferation after 3 days (p<0.0001) (FIG. 1.2). There was no effect found for the nanotube size. The rationale for this is the creation of a positive charge on the surface through the quaternization process with the addition of N+ [30-32]. Osteoblasts are negatively charged and typically repelled by the negative surface of Ti or TiO₂. The addition of the positive charge through quaternization enhanced the attachment of negatively charged osteoblasts. In addition, SEM image (FIG. 1.3) demonstrates elongated cells and multiple fillipods, indicating higher adhesion.

### Anti-Corrosive

As part of the bacterial colonization around the peri-implant site, Ti corrosion is believed to occur from surface degradation of the oxide layer caused by bacterial toxins, which eventually leads to the breakdown of the implant surface. Safioti, et al. [7] reported a significantly higher amount of Ti ions using inductively coupled plasma-atomic emission spectrometry (ICP-MS) in submucosal plaque harvested from peri-implantitis patients, signifying Ti corrosion and surface breakdown. The presence of Ti particles in the peri-implant site initiates giant cell reactions along the peri-implant surface, leading to progression of the disease [7]. Biopsied samples were collected and implant bodies from failed peri-implantitis cases and confirmed the presence of Ti in the biopsied sites along with loss of material on the surface of the failed implants, indicated by increased surface roughness and decreased atomic concentration of Ti on the surface (FIGS. 1.4, 1.5) [34]. In addition, the corrosion was analyzed on non-coated and coated nanotubes using two methods of corrosion: (1) potentiodynamic polarization test and (2) P. gingivalis inoculation for 30 days. Results demonstrated that improved corrosion resistance was seen in SiC coated nanotubes and bacteria on uncoated surfaces caused surface degradation or corrosion (FIG. 1.6).

### QSiCN and SiCN Advances

The customized anodized surface increases surface area and wettability of the surface. The newly developed QSICN coating improves osteoblast activity by producing a positively charged surface that attracts the negatively charged osteoblast cells (FIG. 1.7). Ti and TiO₂ are negatively charged and tend to repel bone forming cells. The positive charge produced by QSiCN, through quaternization with N+, is also the reason for the superb anti-bacterial properties of the coating by causing contact-mediated lipid peroxidation [35], which increases the permeability of the bacterial membrane and leaches out bacterial cytosol causing cell death (FIG. 1.8). This dual mechanism is possible because there is a major difference between eukaryotic cells and bacteria. Eukaryotic cell membranes contain a large amount of cholesterol [36], which can prevent lipid peroxidation by decreasing membrane fluidity and promoting lipid raft formation [37]. Therefore, the positive charges on QSiCN coated TiO₂ nanotubes will not damage the membrane of osteoblast cells but be effective in destroying bacterial cells. In addition, the novel QSICN coating is innovative because it prevents Ti corrosion. Ti corrosion results in surface degradation and the leaching of Ti ions, which have been demonstrated to cause inflammatory reactions in the surrounding tissues and potentially progress to peri-implantitis and alveolar bone resorption [7] [8]. Anodized Ti surfaces are subject to tribocorrosion [38], which overshadows the benefits of bone growth. The application of QSiCN prevents corrosion of this surface. The ideal diameter of nanotubes for osseointegration was confirmed and anti-bacterial properties to be 100 nm-150 nm.

### REFERENCES FOR EXAMPLE 1

1. Dreyer H, Grischke J, Tiede C, and e. al., Epidemiology and risk factors of periimplantitis:
a systematic review. J Periodontal Res, 2018. 53 (5): p. 657-81.
2. Derks, J., D. Schaller, J. Håkansson, J. L. Wennström, C. Tomasi, and T. Berglundh, Effectiveness of Implant Therapy Analyzed in a Swedish Population: Prevalence of Peri-implantitis. Journal of Dental Research, 2016. 95 (1): p. 43-49.
3. Persson, G. R. and S. Renvert, Cluster of bacteria associated with peri-implantitis. Clin Implant Dent Relat Res, 2014. 16 (6): p. 783-93.
4. Jankovic, S., Z. Aleksic, B. Dimitrijevic, V. Lekovic, P. Camargo, and B. Kenney, Prevalence of human cytomegalovirus and Epstein-Barr virus in subgingival plaque at peri-implantitis, mucositis and healthy sites. A pilot study. Int J Oral Maxillofac Surg, 2011. 40 (3): p. 271-6.
5. Esquivel-Upshaw, J. and Clark, A E., Peri-Implant diseases, in Quick Poll Results. 2016, National Dental Practice Based Research Network.
6. Monje, A., L. Aranda, K. T. Diaz, M. A. Alarcon, R. A. Bagramian, H. L. Wang, and A. Catena, Impact of Maintenance Therapy for the Prevention of Peri-implant Diseases: A Systematic Review and Meta-analysis. J Dent Res, 2016. 95 (4): p. 372-9.
7. Safioti, L. M., G. A. Kotsakis, A. E. Pozhitkov, W. O. Chung, and D. M. Daubert, Increased Levels of Dissolved Titanium Are Associated With Peri-Implantitis-A Cross-Sectional Study. Journal of Periodontology, 2017. 88 (5): p. 436-442.
8. Fretwurst, T., K. Nelson, D. P. Tarnow, H. L. Wang, and W. V. Giannobile, Is Metal Particle Release Associated with Peri-implant Bone Destruction? An Emerging Concept. J Dent Res, 2018. 97 (3): p. 259-265.
9. Berglundh, T., O. Gislason, U. Lekholm, L. Sennerby, and J. Lindhe, Histopathological observations of human periimplantitis lesions. J Clin Periodontol, 2004. 31 (5): p. 341-7.
10. Carcuac, O. and T. Berglundh, Composition of human peri-implantitis and periodontitis lesions. J Dent Res, 2014. 93 (11): p. 1083-8.
11. Bullon, P., M. Fioroni, G. Goteri, C. Rubini, and M. Battino, Immunohistochemical analysis of soft tissues in implants with healthy and peri-implantitis condition, and aggressive periodontitis. Clin Oral Implants Res, 2004. 15 (5): p. 553-9.
12. Faot, F., G. G. Nascimento, A. M. Bielemann, T. D. Campão, F. R. Leite, and M. Quirynen, Can peri-implant crevicular fluid assist in the diagnosis of peri-implantitis? A systematic review and meta-analysis. J Periodontol, 2015. 86 (5): p. 631-45.
13. Xia, X., C. C. Chiang, S. K. Gopalakrishnan, A. V. Kulkarni, F. Ren, K. J. Ziegler, and J. F. Esquivel-Upshaw, Properties of SiCN Films Relevant to Dental Implant Applications. Materials (Basel), 2023. 16 (15).
14. Knight, J. D. and A. D. Miranker, Phospholipid catalysis of diabetic amyloid assembly. J Mol Biol, 2004. 341 (5): p. 1175-87.
15. Terakawa, M. S., Y. Lin, M. Kinoshita, S. Kanemura, D. Itoh, T. Sugiki, M. Okumura, A. Ramamoorthy, and Y. H. Lee, Impact of membrane curvature on amyloid aggregation. Biochim Biophys Acta Biomembr, 2018. 1860 (9): p. 1741-1764.
16. Lira, R. B., F. S. C. Leomil, R. J. Melo, K. A. Riske, and R. Dimova, To Close or to Collapse: The Role of Charges on Membrane Stability upon Pore Formation. Adv Sci (Weinh), 2021. 8 (11): p. e2004068.
17. Ausilio, C., C. Lubrano, A. Mariano, and F. Santoro, Negatively-charged supported lipid bilayers regulate neuronal adhesion and outgrowth. RSC Advances, 2022. 12 (47): p. 30270-30277.
18. Kozio?, A., E. Grela, K. Macegoniuk, A. Grabowiecka, and S. Lochy?ski, Synthesis of nitrogen-containing monoterpenoids with antibacterial activity. Nat Prod Res, 2020. 34 (8): p. 1074-1079.
19. Kerru, N., L. Gummidi, S. Maddila, K. K. Gangu, and S. B. Jonnalagadda, A Review on Recent Advances in Nitrogen-Containing Molecules and Their Biological Applications. Molecules, 2020. 25 (8): p. 1909.

20 Duosiken, D., R. Yang, Y. Dai, Z. Marfavi, Q. Lv, H. Li, K. Sun, and K. Tao, Near-Infrared Light-Excited Reactive Oxygen Species Generation by Thulium Oxide Nanoparticles. J Am Chem Soc, 2022. 144 (6): p. 2455-2459.
21. Dryden, M., Reactive oxygen species: a novel antimicrobial. Int J Antimicrob Agents, 2018. 51 (3): p. 299-303.
22. Pan, D., Q. Wan, and G. Galli, The refractive index and electronic gap of water and ice increase with increasing pressure. Nat Commun, 2014. 5: p. 3919.
23. Chiang, C.-C., X. Xia, V. Craciun, M. G. Rocha, S. E. A. Camargo, F. R. G. Rocha, S. K. Gopalakrishnan, K. J. Ziegler, F. Ren, and J. F. Esquivel-Upshaw, Enhancing the Hydrophobicity and Antibacterial Properties of SiCN-Coated Surfaces with Quaternization to Address Peri-Implantitis. Materials, 2023. 16 (17): p. 5751.
24. Haldar, J., P. Kondaiah, and S. Bhattacharya, Synthesis and antibacterial properties of novel hydrolyzable cationic amphiphiles. Incorporation of multiple head groups leads to impressive antibacterial activity. J Med Chem, 2005. 48 (11): p. 3823-31.
25. Rawlinson, L. A., S. M. Ryan, G. Mantovani, J. A. Syrett, D. M. Haddleton, and D. J. Brayden, Antibacterial effects of poly(2-(dimethylamino ethyl) methacrylate) against selected gram-positive and gram-negative bacteria. Biomacromolecules, 2010. 11 (2): p. 443-53.
26. Chen, Z., Z. Wang, W. Qiu, and F. Fang, Overview of Antibacterial Strategies of Dental Implant Materials for the Prevention of Peri-Implantitis. Bioconjug Chem, 2021. 32 (4): p. 627-638.
27 Afonso Camargo S E, Mohiuddeen A S, Fares C, Partain J L, I. Carey P H, Ren F, Hsu S-M, Clark A E, and E.-U. J F., Anti-Bacterial Properties and Biocompatibility of Novel SiC Coating for Dental Ceramic. Journal of Functional Biomaterials, 2020. 11 (2): p. 33-41.

28 Camargo S E A, Roy T, Carey I V P H, Fares C, Ren F, Clark A E, and E.-U. J F., Novel Coatings to Minimize Bacterial Adhesion and Promote Osteoblast Activity for Titanium Implants . . . Journal of Functional Biomaterials, 2020. 11 (2): p. 42-51.
29. Calderon, P. D. S., F. R. G. Rocha, X. Xia, S. E. A. Camargo, A. L. B. Pascoal, C. W. Chiu, F. Ren, S. Ghivizzani, and J. F. Esquivel-Upshaw, Effect of Silicon Carbide Coating on Osteoblast Mineralization of Anodized Titanium Surfaces. J Funct Biomater, 2022. 13 (4).
30. Metwally, S. and U. Stachewicz, Surface potential and charges impact on cell responses on biomaterials interfaces for medical applications. Materials Science and Engineering: C, 2019. 104: p. 109883.
31. Zhang, W., N. Liu, H. Shi, J. Liu, L. Shi, B. Zhang, H. Wang, J. Ji, and P. K. Chu, Upregulation of BMSCs Osteogenesis by Positively-Charged Tertiary Amines on Polymeric Implants via Charge/iNOS Signaling Pathway. Scientific Reports, 2015. 5 (1): p. 9369.
32. Guo, C. Y., J. P. Matinlinna, and A. T. Tang, Effects of surface charges on dental implants: past, present, and future. Int J Biomater, 2012. 2012: p. 381535.
33. Smeets, R., A. Kolk, M. Gerressen, O. Driemel, O. Maciejewski, B. Hermanns-Sachweh, D. Riediger, and J. M. Stein, A new biphasic osteoinductive calcium composite material with a negative Zeta potential for bone augmentation. Head Face Med, 2009. 5: p. 13.
34. Soler, M., S. Hsu, C. Fares, F. Ren, R. Jenkins, L. Gonzaga, A. Clark, E. O'Neill, D. Neal, and J. Esquivel-Upshaw, Titanium corrosion in peri-implantitis. Materials, 2020. 13.
35. Shrestha, A. and A. Kishen, Antibacterial Nanoparticles in Endodontics: A Review. J Endod, 2016. 42 (10): p. 1417-26.
36. Brender, J., A. McHenry, and A. Ramamoorthy, Does Cholesterol Play a Role in the Bacterial Selectivity of Antimicrobial Peptides? Frontiers in Immunology, 2012. 3.
37 Zhao, X., X. Lian, J. Xie, and G. Liu, Accumulated cholesterol protects tumours from elevated lipid peroxidation in the microenvironment. Redox Biol, 2023. 62: p. 102678.
38 Manoj, A., A. K. Kasar, and P. L. Menezes, Tribocorrosion of Porous Titanium Used in Biomedical Applications. Journal of Bio- and Tribo-Corrosion, 2018. 5: p. 1-16.

### Example 2

The application of surface coatings is a popular technique to improve the performance of materials used for medical and dental implants. Ternary silicon carbon nitride (SiCN), obtained by introducing nitrogen into SiC, has attracted significant interest due to its potential advantages. This study investigated the properties of SiCN films deposited via PECVD for dental implant coatings. Chemical composition, optical, and tribological properties were analyzed by adjusting the gas flow rates of NH₃, CH₄, and SiH₄. The results indicated that an increase in the NH₃ flow rate led to higher deposition rates, scaling from 5.7 nm/min at an NH₃ flow rate of 2 sccm to 7 nm/min at an NH₃ flow rate of 8 sccm. Concurrently, the formation of N—Si bonds was observed. The films with a higher nitrogen content exhibited lower refractive indices, diminishing from 2.5 to 2.3 as the NH₃ flow rate increased from 2 sccm to 8 sccm. The contact angle of SiCN films had minimal differences, while the corrosion rate was dependent on the pH of the environment. These findings contribute to a better understanding of the properties and potential applications of SiCN films for use in dental implants.

### 1. Introduction

The application of surface coatings is a widely used technique that significantly enhances the performance and prolongs the lifespan of medical and dental implants, making them indispensable in the field of implantology [1,2]. Despite titanium's long-standing success as a dental implant material, recent developments have brought potential replacements to light [3-5]. Consequently, the development of surface coatings that can enhance the performance and durability of dental implants has become a significant area of research [6-8].

One of the main challenges associated with dental implants is the risk of infection. Researchers have been working on developing antibacterial coatings for dental implants to address this issue [4,9,10]. These coatings can inhibit the growth of bacteria on the surface of the implant, reducing the risk of infection and improving implant success rates [11]. Hydrophilic coatings can attract water molecules, which improves the implant's ability to integrate with the surrounding bone tissue. Bioactive coatings are designed to stimulate the growth of new bone tissue around the implant, improving its stability and reducing the risk of implant failure [12]. Nanocoatings are another area of development in dental implant coatings. These coatings are made up of extremely small particles that can be designed to have specific properties, such as antibacterial or bioactive properties [13].

Silicon carbide (SiC) as a dental implant coating material has gained attention due to its exceptional properties, such as its high hardness and wear resistance, leading to a durable and long-lasting coating [14,15]. In addition, SiC demonstrates biocompatibility, exhibiting no deleterious effects when in contact with living tissue. Moreover, SiC coatings exhibit antibacterial properties, which have the potential to reduce the risk of infection in the area surrounding the implant [12].

Ternary silicon carbon nitride (SiCN), obtained by introducing nitrogen into silicon carbide (SiC), has attracted significant interest due to its potential advantages [16,17]. The properties of SiCN coatings can be customized by adjusting the ratio of silicon, carbon, and nitrogen in the coating. This allows the coating to be tailored to specific dental implant applications, providing improved properties and performance. Nitro-gen-containing compounds exhibit antibacterial properties [18,19]. Although the anti-bacterial mechanism of SiCN coatings is not yet fully understood, several potential mechanisms have been proposed. The introduction of nitrogen into the SiC coating to form SiCN may decrease the surface's attractiveness to bacteria, which may lead to a reduction in bacterial colonization and infection risk. Additionally, nitrogen-containing compounds may have an inhibitory effect on bacterial growth [20,21].

Studies have investigated the potential of SiCN as a coating material for joint replacement implants [18,22,23]. Various deposition techniques, including ion beam sputtering assisted deposition [18], high power impulse magnetron sputtering (HiPIMS) [23], thermal chemical vapor deposition (CVD) [22], and plasma-enhanced CVD (PECVD) have been employed to synthesize SiCN coatings [24,25]. Among these processes, PECVD is the preferred technique due to its ability to provide highly con-formal coatings with excellent uniformity over complex geometries [26]. In addition, PECVD offers low-temperature processing, thereby minimizing thermal damage to the implant or temperature-sensitive components [27]. Precise control over the deposition parameters enables tailoring of coating properties, such as thickness, composition, and porosity, to meet specific application requirements [28]. However, few studies have utilized PECVD to develop SiCN coatings for medical or dental implant applications.

This study aims to investigate the chemical composition, optical properties, and tribological properties of SiCN films deposited via PECVD by adjusting the gas flow rates of ammonia (NH₃), methane (CH₄), and silane (SiH₄) to vary the content concentrations. The SiCN films' surface composition, atomic concentration, and chemical bonds were analyzed to obtain insights into the coating's properties. The refractive index was measured to determine the optical properties, while the wettability contact angle was assessed to evaluate the potential antibacterial ability. Additionally, the corrosion rates in different pH solutions (pH 2, pH 7, and pH 10) were studied to assess the coating's suitability for dental applications.

### 2. Materials and Methods

### 2.1. Sample Preparation

The same preparation procedures were used for both the silicon substrate before applying the coatings and the finished samples prior to characterization. The samples were thoroughly cleaned with acetone and isopropyl alcohol, followed by blow-drying with nitrogen. Next, the surfaces were treated with ozone to remove any traces of adventitious carbon.

### 2.2. SiCN Coating

In this study, a plasma-enhanced chemical vapor deposition system (PECVD SLR Series, Plasma-Therm, Saint Petersburg, FL, USA) was used to deposit SiCN onto silicon substrates. The system consisted of a parallel plate configuration, gas shower head, and load lock. NH₃, CH₄, and SiH₄ were used as gas precursors for SiCN deposition. The deposition temperature was set to 350° C., and three sets of experiments were performed with varying gas flow rates for each gas species. The radio frequency (RF) power was set to 50 W and operated at a frequency of 13.56 MHz. The chamber pressure was set to 900 mTorr.

To verify the deposition rate, SiCN was deposited onto reference wafers, and the total thickness was measured using a surface profilometer (Alpha-Step 500, KLA-Tencor, Milpitas, CA, USA).

### 2.3. Characterization Techniques

### 2.3.1. X-Ray Photoelectron Spectroscopy (XPS) Surface Composition Analysis

The surface composition of the SiCN for all conditions studied was determined using a Physical Instruments ULVAC PHI XPS system (ULVAC-PHI, Kanagawa, Japan) and CasaXPS. A source power of 300 W from a monochromatic Al X-ray source (1486.6 eV) was used, along with an electron pass energy of 93.5 eV for the survey scans. The acceptance angle was set at 7°, the take-off angle at 50°, and the analysis spot diameter at 100 μm. The binding energy accuracy was within 0.03 eV, while the overall energy resolution of the XPS was approximately 0.1 eV. Charge correction was carried out using the C—Si peak at 283.5 eV.

### 2.3.2. Deposition Rate Determination

The deposition rates were measured using a surface profilometer (Alpha-Step 500, KLA-Tencor, Milpitas, CA, USA) and calculated. To ensure accurate measurement, part of the substrate area was covered with a glass slide during film deposition. After the deposition and removal of the glass slide, the height difference at the edge of the film was measured using the surface profilometer, and the deposition rate was calculated by di-viding the deposition time.

### 2.3.3. Refractive Index Measurement

The refractive index, a critical parameter in assessing the optical properties of the SiCN films, was determined using a Filmetrics F40 photospectrometer (F40, Filmetrics, San Diego, CA, USA). This instrument, which is known for its high-accuracy measurements of thin-film optical properties, operates by directing light onto the film and quantifying the light reflected back. The resulting data allows for the calculation of the refractive index, indicating how significantly light slows down (or refracts) in the SiCN film compared to a vacuum. This measure provides essential insights into the suitability and potential performance of the SiCN films when used in specific applications such as medical and dental implants.

### 2.3.4. Contact Angles Measurement

Contact angle measurements serve as a key indicator of wettability, which has implications for the adhesion and tribological properties of the SiCN films. These measurements were carried out using a Kruss DSA100 Drop Shape Analyzer (Ham-burg, Germany). This instrument, well regarded for its precision, applies a droplet of liquid to the film surface and then utilizes high-resolution imaging to analyze the shape of the droplet. The angle formed at the liquid-film interface—the contact angle—is then precisely determined. This measure provides valuable information about the surface characteristics of the SiCN films

### 2.3.5. Corrosion Rate Determination

Assessing the corrosion rate of SiCN films under different pH conditions is crucial to understanding their durability and performance in a range of environments. In this experiment, samples were exposed to three distinct buffer solutions with pH levels of 2, 7, and 10, simulating varying acidic, neutral, and basic conditions. Each sample was immersed in its respective solution for a duration of eight hours, after which the extent of corrosion was measured using a surface profilometer. This instrument, used for its ability to accurately gauge surface profile changes, helped determine the corrosion rate of the SiCN films. This information is essential to predict the longevity and stability of the SiCN films, particularly when applied to medical and dental implants which may be exposed to different pH environments.

### 3. Results and Discussion

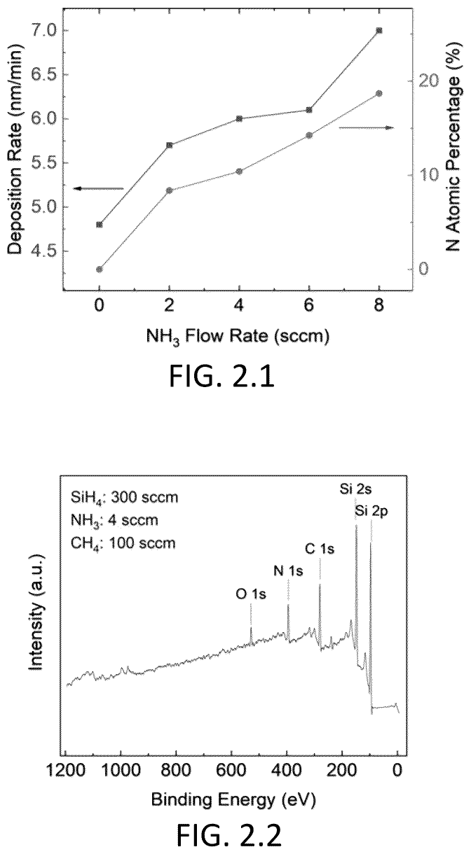

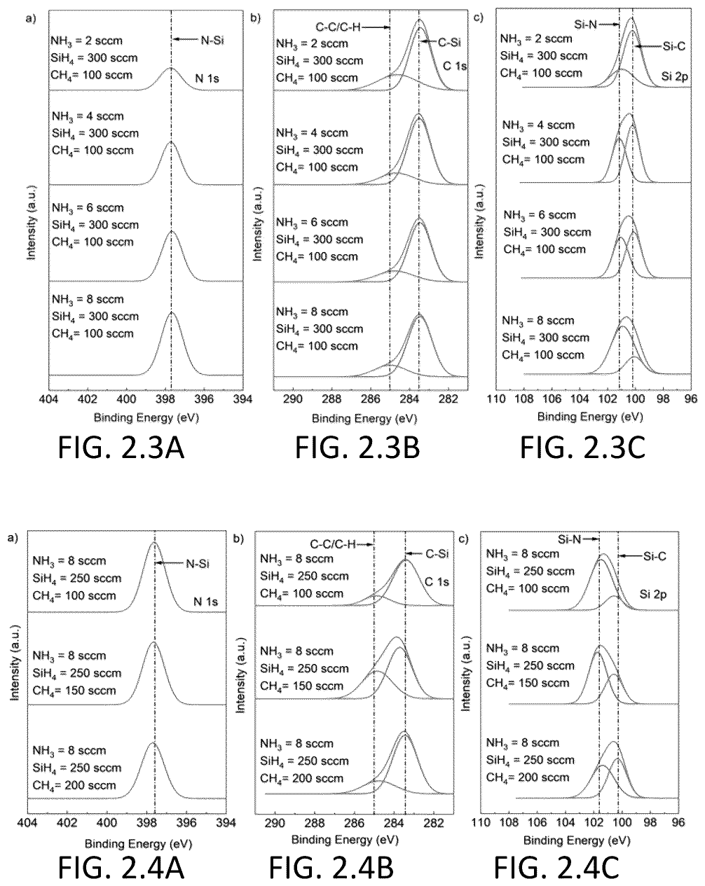

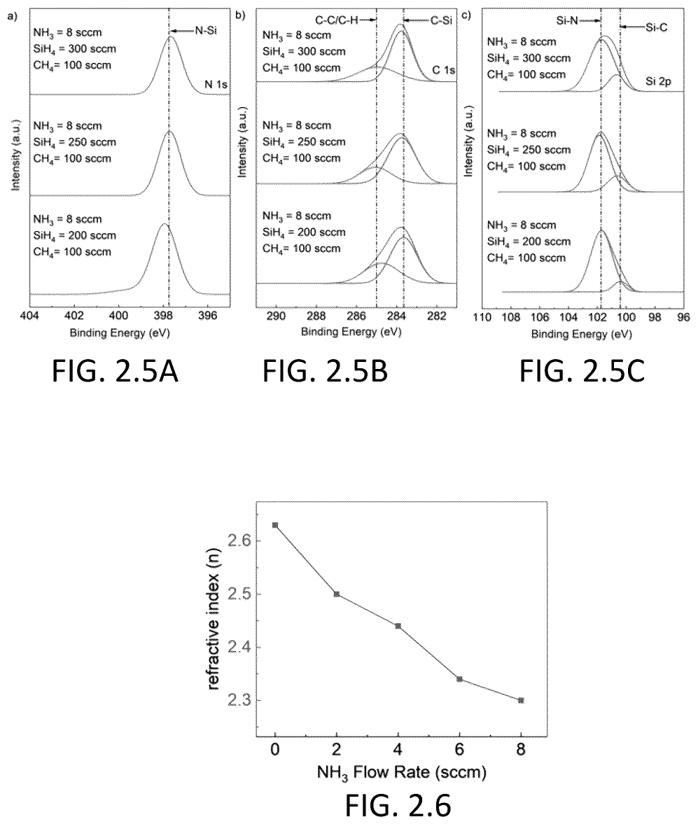

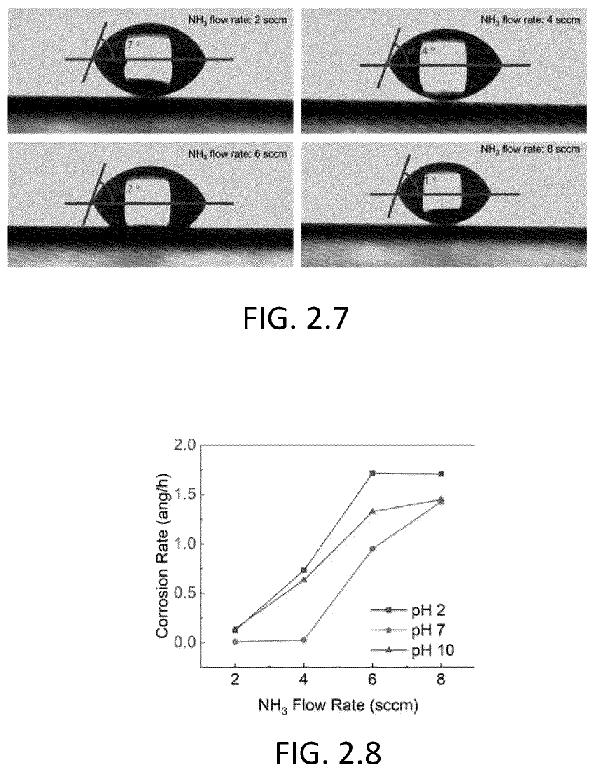

FIG. 2.1 shows that the deposition rate slightly increased with increasing NH₃ flow rate in the experiments with varying NH₃ flow rates. The flow rates of SiH₄ and CH₄ were selected to match those used in previous studies on SiC film formation. The resulting deposition rate of the SiCN film is on the scale of nanometers per minute, which enables fine control over the film thickness for thin film applications. In comparison, the established methods for SiC and SiN coatings for dental implants are typically in the range of 200-500 nm [12,15,29,30]. By depositing a SiCN film with a similar thickness using this process, it is feasible to achieve a high-quality film in a reasonable time frame.

XPS is a surface analysis technique that provides elemental and chemical composition information of a material. Analysis of the XPS spectrum involves identifying the characteristic peaks of the elements present in the sample to determine its chemical composition. The peak position on the XPS spectrum provides information on the chemical and oxidation state of the elements [31]. In this study, CasaXPS software was used to analyze the film's composition, where Gaussian curve fitting was applied to identify peaks, and the area under the curve was used to calculate atomic concentration. The survey scan in FIG. 2.2 showed the presence of Si, C, and N in the film, and the presence of oxygen is due to surface oxidation.

XPS can also be used to identify chemical bonds present in a material by analyzing the binding energy of the electrons that are emitted from the sample after X-ray irradiation [31]. Spectral deconvolution is a common method used to identify chemical bonds in XPS analysis, which separates the contributions of each chemical bond to the overall spectrum. In this study, OriginLab software was utilized to plot and deconvolute the XPS data. The deconvolution technique was performed to identify the chemical shifts from the XPS spectra, and the C—Si peak at 283.5 eV was utilized for charge referencing [32].

The results of XPS composition analysis with different NH₃ flow rates are shown in Table 1. The N content increased from 7.37% to 17.50% with an increasing NH₃ flow rate from 2 sccm to 8 sccm, while the Si and C content decreased. The peak located at 398 eV corresponded to the N—Si peak, and its intensity increased in direct correlation with the NH₃ flow rate. This suggests that the increase in NH₃ flow rate increased the formation of N—Si bonds while attenuating the formation of Si—C bonds. The high-resolution XPS spectra of Si2p, C1s, and N1s core-level peaks for SiCN deposited with different NH₃ flow rates are shown in FIG. 2.3. The main peaks were deconvoluted into peaks according to different chemical bonds, with different bonds having different binding energies. The peak located at 397.7 eV for the N1s spectrum was likely to be the N—Si bonds. The C1 peak was further deconvoluted into C—C or C—H bonds located at 285 eV and a C—Si bonds located at 283.5 eV. Two peaks were deconvoluted from Si2p, with the peak at 101.2 corresponding to Si—N bonds and the peak at 100.3 corresponding to Si—C bonds. The N—Si peak intensity for N1s increased with increasing NH₃ flow rate from 2 sccm to 8 sccm, while the Si—N peak intensity for Si2p increased, and the Si—C peak intensity for Si2p decreased. This is consistent with the atomic ratio result in Table 1, where more N—Si bonds were formed when the NH₃ flow rate increased from 2 sccm to 8 sccm.

TABLE 1
Experimental parameters and results for SiCN deposited by various flow rates.

| | | | | | | | | | Corrosion | | | |
|---|---|---|---|---|---|---|---|---|---|---|---|---|
| | | | | | | | Deposition | Contact | Rate | | | Refractive |
| SiH₄ | NH₃ | CH₄ | Si: | N: | C: | O: | Rate | Angle | (ang/hour) | | | Index |
| (sccm) | (sccm) | (sccm) | (%) | (%) | (%) | (%) | (nm/min) | (°) | pH 2 | pH 7 | pH 10 | (n) |
| 300 | 2 | 100 | 60.09 | 7.37 | 28.54 | 4 | 5.7 | 63.7 | 0.12 | 0.01 | 0.14 | 2.5 |
| 300 | 4 | 100 | 58.73 | 10.41 | 28.85 | 2.01 | 6 | 65.4 | 0.73 | 0.02 | 0.63 | 2.44 |
| 300 | 6 | 100 | 57.1 | 12.04 | 26.16 | 4.7 | 6.1 | 68.7 | 1.71 | 0.95 | 1.32 | 2.34 |
| 300 | 8 | 100 | 52.43 | 17.50 | 25.26 | 4.8 | 7 | 71 | 1.71 | 1.42 | 1.45 | 2.3 |
| 250 | 8 | 100 | 51.73 | 17.90 | 26.17 | 4.2 | — | — | — | — | — | — |
| 250 | 8 | 150 | 46.55 | 17.52 | 31.63 | 4.3 | — | — | — | — | — | — |
| 250 | 8 | 200 | 48.96 | 13.91 | 32.53 | 4.6 | — | — | — | — | — | — |
| 300 | 8 | 100 | 52.43 | 17.50 | 25.26 | 4.8 | — | — | — | — | — | — |
| 250 | 8 | 100 | 51.73 | 17.90 | 26.17 | 4.2 | — | — | — | — | — | — |
| 200 | 8 | 100 | 49.71 | 19.53 | 27.58 | 3.18 | — | — | — | — | — | — |

To investigate the effect of varying CH₄ flow rates on the chemical composition of SiCN films, experiments were conducted with fixed NH₃ flow rates of 8 sccm and fixed SiH₄ flow rates of 250 sccm, while the CH₄ flow rate was changed from 100 sccm to 150 sccm and 200 sccm. The resulting high-resolution XPS spectra and atomic concentration of Si2p, C1s, and N1s core-level peaks for the deposited SiCN films are shown in FIG. 2.4 and Table 1. As expected, an increase in CH₄ flow rate led to a higher carbon content and lower N content in the SiCN films. Specifically, the peak intensity of the C—Si chemical bonding peak in the C1s spectrum and the Si—C bonding peak in the Si2p spectrum in-creased with an increasing CH₄ flow rate. Meanwhile, the intensity of the N—Si peak in the N1s spectrum and Si—N peak in the Si2p spectrum decreased. These observations are consistent with the atomic concentration results presented in Table 1.

To investigate the effect of varying SiH₄ flow rates on the chemical composition of SiCN films, experiments were conducted with fixed NH₃ flow rates of 8 sccm and fixed CH₄ flow rates of 100 sccm. In FIG. 2.5, as the SiH₄ flow rate was decreased, the Si composition of the films also decreased, as evidenced by the decreased intensity of the C—Si peak in the C1s spectrum and the Si—C peak in the Si2p spectrum. No significant decrease in the peak intensity of N—Si in N1s or Si—N in Si2p was observed, indicating that Si—N bond formation was unaffected by the change in SiH₄ flow rate. However, a higher in-tensity of the C—C/C—H bonds peak was found in the C1s spectrum, suggesting increased formation of these bonds with decreasing SiH₄ flow rate.

The nitrogen atoms in SiCN films can create a negatively charged surface, which can interact with positively charged sites on bacterial cell membranes, leading to membrane disruption and cellular damage [33,34]. Additionally, SiCN films can generate reactive oxygen species (ROS) upon exposure to light or heat, which can further damage bacterial cells [35,36].

The negative charge on SiCN surfaces is primarily generated through the formation of N—Si bonds, which results from the presence of nitrogen atoms in the material. In the N—Si bond, the nitrogen atom donates a lone pair of electrons to form a covalent bond with the silicon atom, creating a negatively charged nitrogen atom and a positively charged silicon atom. This negatively charged nitrogen atom can interact with positively charged sites on bacterial cell membranes, leading to membrane disruption and cellular damage [37-40].

In this study, it was found that the NH₃ flow rate plays a significant role in the formation of N—Si bonds in SiCN films. Furthermore, N—Si bonds were present in all of the examined SiCN films. These findings provide insight into the mechanism underlying the antibacterial properties of SiCN films and have implications for their potential use in medical and dental applications.

FIG. 2.6 depicts the refractive indices of SiCN films produced under varying NH₃ flow rates, specifically within a range of 2 to 8 cm. These refractive indices were determined utilizing a photospectrometer at a wavelength of 632 nm. An inverse relationship between the NH₃ flow rate and the refractive index of the SiCN films is noticeable, with an increase in the NH₃ flow rate leading to a decrease in the refractive index. This phenomenon is likely due to the increased integration of nitrogen (N) into the film with elevated NH₃ flow rates, as validated by the high-resolution XPS data contained in Table 1 and FIG. 2.3. The observed shift in refractive index carries significant implications for the practical uses of SiCN films. High refractive indices can enhance the optical properties of dental coatings, increasing the brightness and translucency of tooth-colored restorations, a finding supported by Chen et al., 2019 [41]. Conversely, an increase in the refractive index might contribute to an increase in coating brittleness, rendering them more prone to cracking or chipping, as reported by Pan et al., 2014 [42]. Such vulnerability may negatively impact the material's long-term performance and durability. Consequently, the optimal refractive index for dental coatings may be ap-plication-specific and require a careful balance between optical and mechanical properties. Future investigations should aim at determining this optimal balance to unlock the full potential of SiCN films in dental applications.

FIG. 2.7 illustrates the impact of NH₃ flow rate on the wettability of SiCN. The SiCN film deposited with a higher NH₃ flow rate displayed slightly larger contact angles, ranging from 63.7° at 2 sccm to 71° at 8 sccm. However, the change in contact angle was relatively small. An excessively hydrophobic surface can repel water and create a barrier that prevents bacteria from attaching. On the other hand, an extremely hydrophilic surface can cause water to spread out, reducing the contact area between the bacteria and the surface, which also reduces bacterial adhesion [43-46]. An extremely hydrophilic surface would have a contact angle close to 0°, while an extremely hydrophobic surface would have a contact angle close to 180° [47,48]. The SiCN film in this study does not belong to an extremely hydrophobic or hydrophilic surface, so it may not benefit in reducing bacteria attachment.

The corrosion rate of SiCN, as depicted in FIG. 2.8, was found to be influenced by the pH of the surrounding environment. For all SiCN films deposited at varying NH₃ flow rates, the corrosion rate was highest at pH 2, followed by pH 10, while the corrosion rate at pH 7 was lower than at either pH 2 or pH 10. Furthermore, it was observed that a higher NH₃ flow rate during SiCN film deposition led to increased nitrogen content in the film, resulting in a greater corrosion rate. A higher proportion of Si—N bonds relative to Si—C bonds, which may be more susceptible to hydrolysis and attack by H+ or OH− ions, could explain this increased corrosion rate.

In highly acidic conditions (pH 2), the elevated concentration of H+ ions could accelerate the corrosion rate, as these ions react with SiCN, breaking Si—C and Si—N bonds and forming soluble silicic acid (H₄SiO₄) or other hydrolyzed species. In highly alkaline conditions (pH 10), the high concentration of OH− ions also may increase the corrosion rate by reacting with SiCN, breaking Si—C and Si—N bonds, and forming soluble silicate species or other hydrolyzed products. In neutral conditions (pH 7), the corrosion rate is generally lower due to the reduced concentration of aggressive ions (e.g., H+ and OH−), allowing SiCN to form a more stable and protective oxide layer on its surface [49,50]. This finding is consistent with previous studies on silicon carbide (SiC) coatings on glass-ceramic disks, where the corrosion rate followed the order pH 2>pH 10>pH 7 [51]. The comparable corrosion rates at pH 7 and pH 10 for an NH₃ flow rate of 8 sccm might be attributed to the increased nitrogen content in the SiCN film due to the high NH₃ flow rate. An elevated number of Si—N bonds, which are potentially more vulnerable to hydrolysis and ion attack, could escalate the corrosion rate. Consequently, the typically protective effect of the neutral pH 7 conditions may be undermined.

Considering that the healthy pH of saliva is approximately 7, and that acidic or basic substances such as citric or acidic solutions (e.g., Coca-Cola pH 2.45, orange juice pH 3.74, wines pH 3.34-3.68) and basic foods (e.g., spinach, soybeans, and antacids) [52-55] can alter the pH of the oral environment, the corrosion rate of SiCN films in vivo could be affected. Therefore, the corrosion rate of SiCN films under different pH conditions should be considered when evaluating their potential application as dental implant coatings.

### 4. Conclusions

This research represents a pioneering investigation into the potential application of SiCN films in dental implants, utilizing the PECVD technique for film deposition. While earlier studies have discussed the merits of SiCN for joint implants, this study breaks new ground by focusing on dental applications.

The extensive examination conducted here assessed the impact of varying NH₃, CH₄, and SiH₄ flow rates on several critical characteristics of the SiCN films, including their chemical composition, antibacterial properties, refractive index, wettability, and corrosion rate. It was discerned that the SiCN film deposition rate increased with higher NH₃ flow rates, producing nanometer-scale films that offer precise control over thickness, a crucial attribute for thin-film applications.

The formation of N—Si bonds, driven by the NH₃ flow rate, emerged as a significant factor, potentially boosting the antibacterial properties of SiCN films by inducing a negatively charged surface capable of interacting with bacterial cell membranes. SiCN films with higher N content presented lower refractive indices. However, the optimal refractive index may depend on the specific dental application, necessitating a delicate balance between optical and mechanical properties.

Although the contact angle exhibited relatively minor changes, it was noted that this might not be instrumental in reducing bacterial attachment to SiCN films. The study also uncovered a correlation between the corrosion rate and pH, indicating that the acidic or basic substances in the oral environment could potentially influence the in vivo corrosion rate of SiCN films.

In conclusion, this study significantly contributes to the existing knowledge about SiCN films, particularly regarding their potential as dental implant coatings. By lever-aging the PECVD technique, a promising pathway has been opened towards the development of superior dental coatings, setting the stage for further advances in dental im-plant technology. This research provides a strong foundation for future explorations in this domain and paves the way for the realization of the full potential of SiCN films in dental applications.

### REFERENCES FOR EXAMPLE 2

1. Pye, A.; Lockhart, D.; Dawson, M.; Murray, C.; Smith, A. A review of dental implants and infection. J. Hosp. Infect. 2009, 72, 104-110.
2. Kasemo, B.; Gold, J. Implant surfaces and interface processes. Adv. Dent. Res. 1999, 13, 8-20.
3. Dong, H.; Liu, H.; Zhou, N.; Li, Q.; Yang, G.; Chen, L.; Mou, Y. Surface modified techniques and emerging functional coating of dental implants. Coatings 2020, 10, 1012.
4. Chouirfa, H.; Bouloussa, H.; Migonney, V.; Falentin-Daudré, C. Review of titanium surface modification techniques and coatings for antibacterial applications. Acta Biomater. 2019, 83, 37-54.
5. Mecholsky, J. J.; Hsu, S. M.; Jadaan, O.; Griggs, J.; Neal, D.; Clark, A. E.; Xia, X.; Esquivel-Upshaw, J. F. Forensic and reliability analyses of fixed dental prostheses. J. Biomed. Mater. Res. Part B Appl. Biomater. 2021, 109, 1360-1368.
6. Fickl, S.; Kebschull, M.; Calvo-Guirado, J. L.; Hürzeler, M.; Zuhr, O. Experimental peri-implantitis around different types of implants-A clinical and radiographic study in dogs. Clin. Implant. Dent. Relat. Res. 2015, 17, e661-e669.
7. Jemat, A.; Ghazali, M. J.; Razali, M.; Otsuka, Y. Surface modifications and their effects on titanium dental implants. BioMed Res. Int. 2015, 791725.
8. Saini, M.; Singh, Y.; Arora, P.; Arora, V.; Jain, K. Implant biomaterials: A comprehensive review. World J. Clin. Cases WJCC 2015, 3, 52.
9. Esquivel-Upshaw, J. F.; Ren, F.; Carey, P.; Clark, A. E., Jr.; Batich, C. D. Quarternized Titanium-Nitride Anti-Bacterial Coating for Dental Implants. U.S. patent application Ser. No. 17/258,022, 2021.
10. Calderon, P. d. S.; Rocha, F. R. G.; Xia, X.; Camargo, S. E. A.; Pascoal, A. L. d. B.; Chiu, C. W.; Ren, F.; Ghivizzani, S.; Esquiv-el-Upshaw, J. F. Effect of Silicon Carbide Coating on Osteoblast Mineralization of Anodized Titanium Surfaces. J. Funct. Biomater. 2022, 13, 247.
11. Zeng, L.; Walker, A. R.; Calderon, P. d. S.; Xia, X.; Ren, F.; Esquivel-Upshaw, J. F. The Effect of Amino Sugars on the Compo-sition and Metabolism of a Microcosm Biofilm and the Cariogenic Potential against Teeth and Dental Materials. J. Funct. Biomater. 2022, 13, 223.
12. Camargo, S. E. A.; Roy, T.; Xia, X.; Fares, C.; Hsu, S. M.; Ren, F.; Clark, A. E.; Neal, D.; Esquivel-Upshaw, J. F. Novel coatings to minimize corrosion of titanium in oral biofilm. Materials 2021, 14, 342.
13. Camargo, S. E. A.; Xia, X.; Fares, C.; Ren, F.; Hsu, S. M.; Budei, D.; Aravindraja, C.; Kesavalu, L.; Esquivel-Upshaw, J. F. Nanostructured Surfaces to Promote Osteoblast Proliferation and Minimize Bacterial Adhesion on Titanium. Materials 2021, 14, 4357.
14. Hsu, S. M.; Fares, C.; Xia, X.; Rasel, M. A. J.; Ketter, J.; Afonso Camargo, S. E.; Haque, M. A.; Ren, F.; Esquivel-Upshaw, J. F. In vitro corrosion of SiC-coated anodized Ti nano-tubular surfaces. J. Funct. Biomater. 2021, 12, 52.
15. Fares, C.; Hsu, S. M.; Xian, M.; Xia, X.; Ren, F.; Mecholsky, J. J., Jr.; Gonzaga, L.; Esquivel-Upshaw, J. Demonstration of a SiC protective coating for titanium implants. Materials 2020, 13, 3321.
16. Kaloyeros, A. E.; Pan, Y.; Goff, J.; Arkles, B. Silicon nitride and silicon nitride-rich thin film technologies: State-of-the-art processing technologies, properties, and applications. ECS J. Solid State Sci. Technol. 2020, 9, 063006.
17. Michelle Morcos, R.; Mera, G.; Navrotsky, A.; Varga, T.; Riedel, R.; Poli, F.; Müller, K. Enthalpy of formation of carbon-rich polymer-derived amorphous SiCN ceramics. J. Am. Ceram. Soc. 2008, 91, 3349-3354.
18 Liang, Y.; Liu, D.; Bai, W.; Tu, J. Investigation of silicon carbon nitride nanocomposite films as a wear resistant layer in vitro and in vivo for joint replacement applications. Colloids Surf. B Biointerfaces 2017, 153, 41-51.
19. Xie, E.; Ma, Z.; Lin, H.; Zhang, Z.; He, D. Preparation and characterization of SiCN films. Opt. Mater. 2003, 23, 151-156.
20. Pandian, C. J.; Palanivel, R.; Balasundaram, U. Green synthesized nickel nanoparticles for targeted detection and killing of S. typhimurium. J. Photochem. Photobiol. B Biol. 2017, 174, 58-69.
21 Travlou, N. A.; Giannakoudakis, D. A.; Algarra, M.; Labella, A. M.; Rodríguez-Castellón, E.; Bandosz, T. J. S- and N-doped carbon quantum dots: Surface chemistry dependent antibacterial activity. Carbon 2018, 135, 104-111.
22. Pettersson, M.; Berlind, T.; Schmidt, S.; Jacobson, S.; Hultman, L.; Persson, C.; Engqvist, H. Structure and composition of silicon nitride and silicon carbon nitride coatings for joint replacements. Surf. Coat. Technol. 2013, 235, 827-834.
23. Pettersson, M.; Tkachenko, S.; Schmidt, S.; Berlind, T.; Jacobson, S.; Hultman, L.; Engqvist, H.; Persson, C. Mechanical and tribological behavior of silicon nitride and silicon carbon nitride coatings for total joint replacements. J. Mech. Behav. Biomed. Mater. 2013, 25, 41-47.
24. Ermakova, E.; Rumyantsev, Y.; Shugurov, A.; Panin, A.; Kosinova, M. PECVD synthesis, optical and mechanical properties of silicon carbon nitride films. Appl. Surf. Sci. 2015, 339, 102-108.
25. Jedrzejowski, P.; Cizek, J.; Amassian, A.; Klemberg-Sapieha, J.; Vlcek, J.; Martinu, L. Mechanical and optical properties of hard SiCN coatings prepared by PECVD. Thin Solid Films 2004, 447, 201-207.
26. Martinu, L.; Zabeida, O.; Klemberg-Sapieha, J. Plasma-enhanced chemical vapor deposition of functional coatings. In Handbook of Deposition Technologies for Films and Coatings; Elsevier: Amsterdam, The Netherlands, 2010; pp. 392-465.1
27. Jun, T.; Song, K.; Jeong, Y.; Woo, K.; Kim, D.; Bae, C.; Moon, J. High-performance low-temperature solution-processable ZnO thin film transistors by microwave-assisted annealing. J. Mater. Chem. 2011, 21, 1102-1108.
28. Huang, H.; Winchester, K.; Suvorova, A.; Lawn, B.; Liu, Y.; Hu, X.; Dell, J.; Faraone, L. Effect of deposition conditions on mechanical properties of low-temperature PECVD silicon nitride films. Mater. Sci. Eng. A 2006, 435, 453-459.
29. Lei, X.; Kane, S.; Cogan, S.; Lorach, H.; Galambos, L.; Huie, P.; Mathieson, K.; Kamins, T.; Harris, J.; Palanker, D. SiC pro-tective coating for photovoltaic retinal prostheses. In Silicon Carbide Technology for Advanced Human Healthcare Applications; Elsevier: Amsterdam, The Netherlands, 2022; pp. 99-123.
30. Kalisz, M.; Grobelny, M.; S'winiarskib, M.; Firek, P. Comparison of the structural and corrosion properties of the gra-phene/SiN (200) coating system deposited on titanium alloy surfaces covered with SiN transition layers. Surf. Coat. Technol. 2016, 299, 65-70.
31. Beamson, G.; Briggs, D.; High Resolution XPS of Organic Polymers, the scienta ESCA300 database; Wiley: Hoboken, NJ, USA, 1992.
32. Wagner, C.; Naumkin, A.; Kraut-Vass, A.; Allison, J.; Powell, C.; Rumble, J., Jr. NIST Standard Reference Database 20, Version 3.4 (Web Version); National Institute of Standards and Technology: Gaithersburg, MD, USA, 2003; pp. 20899.
33 Kozioł, A.; Grela, E.; Macegoniuk, K.; Grabowiecka, A.; Lochyn'ski, S. Synthesis of nitrogen-containing monoterpenoids with antibacterial activity. Nat. Prod. Res. 2020, 34, 1074-1079.
34 Kerru, N.; Gummidi, L.; Maddila, S.; Gangu, K. K.; Jonnalagadda, S. B. A review on recent advances in nitrogen-containing molecules and their biological applications. Molecules 2020, 25, 1909.
35. Duosiken, D.; Yang, R.; Dai, Y.; Marfavi, Z.; Lv, Q.; Li, H.; Sun, K.; Tao, K. Near-infrared light-excited reactive oxygen species generation by thulium oxide nanoparticles. J. Am. Chem. Soc. 2022, 144, 2455-2459.
36. Dryden, M. Reactive oxygen species: A novel antimicrobial. Int. J. Antimicrob. Agents 2018, 51, 299-303.
37 Knight, J. D.; Miranker, A. D. Phospholipid catalysis of diabetic amyloid assembly. J. Mol. Biol. 2004, 341, 1175-1187.
38. Terakawa, M. S.; Lin, Y.; Kinoshita, M.; Kanemura, S.; Itoh, D.; Sugiki, T.; Okumura, M.; Ramamoorthy, A.; Lee, Y. H. Impact of membrane curvature on amyloid aggregation. Biochim. Biophys. Acta (BBA)-Biomembr. 2018, 1860, 1741-1764.
39. Lira, R. B.; Leomil, F. S.; Melo, R. J.; Riske, K. A.; Dimova, R. To close or to collapse: The role of charges on membrane stability upon pore formation. Adv. Sci. 2021, 8, 2004068.
40. Ausilio, C.; Lubrano, C.; Mariano, A.; Santoro, F. Negatively-charged supported lipid bilayers regulate neuronal adhesion and outgrowth. RSC Adv. 2022, 12, 30270-30277.
41. Chen, Z.; Fares, C.; Elhassani, R.; Ren, F.; Kim, M.; Hsu, S. M.; Clark, A. E.; Esquivel-Upshaw, J. F. Demonstration of SiO2/SiC-based protective coating for dental ceramic prostheses. J. Am. Ceram. Soc. 2019, 102, 6591-6599.
42. Pan, D.; Wan, Q.; Galli, G. The refractive index and electronic gap of water and ice increase with increasing pressure. Nat. Commun. 2014, 5, 3919.
43 Xu, J.; Ji, M.; Li, L.; Wu, Y.; Yu, Q.; Chen, M. Improving wettability, antibacterial and tribological behaviors of zirconia ce-ramics through surface texturing. Ceram. Int. 2022, 48, 3702-3710.
44. Valiei, A.; Lin, N.; Mckay, G.; Nguyen, D.; Moraes, C.; Hill, R. J.; Tufenkji, N. Surface wettability is a key feature in the mechano-bactericidal activity of nanopillars. ACS Appl. Mater. Interfaces 2022, 14, 27564-27574.
45. Zhang, X.; Bai, R.; Sun, Q.; Zhuang, Z.; Zhang, Y.; Chen, S.; Han, B. Bio-inspired special wettability in oral antibacterial applications. Front. Bioeng. Biotechnol. 2022, 10, 1001616.
46. Rezaei, F.; Abbasi-Firouzjah, M.; Shokri, B. Investigation of antibacterial and wettability behaviours of plasma-modified PMMA films for application in ophthalmology. J. Phys. D Appl. Phys. 2014, 47, 085401.
47 Boinovich, L. B.; Modin, E. B.; Aleshkin, A. V.; Emelyanenko, K. A.; Zulkarneev, E. R.; Kiseleva, I. A.; Vasiliev, A. L.; Emelya-nenko, A. M. Effective antibacterial nanotextured surfaces based on extreme wettability and bacteriophage seeding. ACS Appl. Nano Mater. 2018, 1, 1348-1359.
48. Wang, L.; Guo, X.; Zhang, H.; Liu, Y.; Wang, Y.; Liu, K.; Liang, H.; Ming, W. Recent Advances in Superhydrophobic and Antibacterial Coatings for Biomedical Materials. Coatings 2022, 12, 1469.
49. Moulder, J.; Stickle, W.; Sobol, P.; Bomben, K.; Chastain, J. Physical electronics division. In Handbook of X-Ray Photoelectron Spectroscopy; Perkin-Elmer Corporation, Minnesota, USA, 1995.
50. Ohring, M.; Mechanical properties of thin films. In: Materials Science of Thin Films; Academic Press, San Diego, USA, 2002; pp. 711-781.
51. Hsu, S. M.; Ren, F.; Chen, Z.; Kim, M.; Fares, C.; Clark, A. E.; Neal, D.; Esquivel-Upshaw, J. F. Novel coating to minimize corrosion of glass-ceramics for dental applications. Materials 2020, 13, 1215.
52. Reddy, A.; Norris, D. F.; Momeni, S. S.; Waldo, B.; Ruby, J. D. The pH of beverages available to the American consumer. J. Am. Dent. Assoc. 2016, 147, 255.
53. Seow, W.; Thong, K. Erosive effects of common beverages on extracted premolar teeth. Aust. Dent. J. 2005, 50, 173-178.
54. Kumar, N.; Amin, F.; Hashem, D.; Khan, S.; Zaidi, H.; Rahman, S.; Farhan, T.; Mahmood, S. J.; Asghar, M. A.; Zafar, M. S. Evaluating the pH of Various Commercially Available Beverages in Pakistan: Impact of Highly Acidic Beverages on the Surface Hardness and Weight Loss of Human Teeth. Biomimetics 2022, 7, 102.
55. Maeda, T.; Yamaguchi, K.; Takamizawa, T.; Rikuta, A.; Tsubota, K.; Ando, S.; Miyazaki, M. pH changes of self-etching primers mixed with powdered dentine. J. Dent. 2008, 36, 606-610.

### Example 3

Peri-implantitis is a major cause of dental implant failure. This disease is an inflammation of the tissues surrounding the implant, and, while the cause is multi-factorial, bacteria is the main culprit in initiating an inflammatory reaction. Dental implants with silicon carbonitride (SiCN) coatings have several potential advantages over traditional titanium implants, but their antibacterial efficiency has not yet been evaluated. The purpose of this study was to determine the anti-bacterial potential of SiCN by modifying the surface of SiCN-coated implants to have a positive charge on the nitrogen atoms through the quaternization of the surface atoms. The changes in surface chemistry were confirmed using contact angle measurement and XPS analysis. The modified SiCN surfaces were inoculated with Streptococcus mutans (S. mutans) and compared with a silicon control. The cultured bacterial colonies for the experimental group were 80% less than the control silicon surface. Fluorescent microscopy with live bacteria staining demonstrated significantly reduced bacterial coverage after 3 and 7 days of incubation. Scanning electron microscopy (SEM) was used to visualize the coated surfaces after bacterial inoculation, and the mechanism for the anti-bacterial properties of the Q SiCN was confirmed by observing ruptured bacteria membrane along the surface.

### 1. Introduction

Dental implants have revolutionized modern dentistry by providing an effective alternative for tooth replacement. According to a recent comprehensive analysis and meta-analysis, dental implants have a potential 10-year survival rate of up to 96.4% [1]. However, peri-implantitis has emerged as a significant concern in the practice of implant dentistry. Peri-implantitis is usually characterized by inflammation and bone loss, which ultimately lead to implant failure [2,3]. Increased implant failure rates result in significant morbidity and increased healthcare costs [4-7]. Conventional treatment approaches, including mechanical debridement and antimicrobial therapy, have limitations in effectively managing peri-implantitis [8-11]. Prevention strategies that focus on reducing bacterial colonization and biofilm formation on the implant surface are considered critical factors in the development and progression of peri-implantitis [12,13].

In recent years, the surface modification of implant materials has emerged as a promising strategy to enhance the antibacterial ability of implants and mitigate the risk of peri-implantitis. The surface properties of implants, such as roughness, hydrophobicity/hydrophilicity, and charge, can be altered to influence bacterial adhesion, colonization, and biofilm formation [14-16]. Various surface-modification techniques, including physical, chemical, and biological approaches, have been investigated to improve the antibacterial ability of implants. For example, Harris et al. utilized poly(L-lysine)-grafted poly(ethylene glycol) (PLL-g-PEG) to create an antiadhesive surface on titanium which reduced 90% of Staphylococcus aureus on the modified surface [17]. Nishida et al. developed a surface modification using carboxymethyl betaine (CMB) to create an anti-fouling surface, highlighting the potential of zwitterionic polymers as a viable option for the surface modification of dental implants [18]. In our prior research, numerous investigations were conducted to confirm the viability of utilizing silicon carbide (SiC) coating on dental implants. This involved studying the cytotoxicity and biocompatibility of this coating using human osteoblasts [19], as well as demonstrating SiC's corrosion protection capabilities [20]. Additionally, the simulation of installing coated implants into human bone [21], along with the potential of SiC coating for cell proliferation and mineralization, have also been demonstrated [19].

Aside from the various methods mentioned earlier for modifying the surface of implants, research has shown promising bactericidal effects from surfaces containing quaternized nitrogen, where positively charged nitrogen atoms take the leading role [22-25]. It has also been demonstrated that the quaternization of a surface coating can be a successful approach in enhancing the antibacterial characteristics of the implant sur-face [26-29]. The majority of bacterial cellular membranes possess a negative charge, making them susceptible to being targeted by cationic biocides [30-32]. As a result, molecules containing nitrogen atoms in a quaternary state have been observed to disrupt the cell wall of bacteria, causing the leakage of cell contents and eventual cell death through apoptosis [33,34].

On the other hand, decreasing the chance for bacteria biofilms to form on dental implants is also the main means of preventing the onset of peri-implantitis, since certain bacteria must inhabit the dental implant first [35-37]. Before the microbiota undergoes a transition to the late stage, S. mutans play a significant role in the formation of oral bacterial biofilms during their early stages [38-40]. DNA Pyrosequencing of plaque samples from peri-implantitis patients revealed S. mutans as one of the predominant species in the associated biofilms [41]. Various studies have also been conducted to evaluate the connections between S. mutans and peri-implantitis, from its adherence, viability, and migration on implant surfaces to biofilm analysis after different treatments [37,42,43]. In addition, due to its characteristic of being a facultative anaerobe organism, S. mutans is also a perfect candidate to mimic the environment of both the related aerobic and anaerobic bacteria causing peri-implantitis [44].

The aim of this study was to quaternize SiCN coating and determine the potential of this modified QSiCN coating for increased hydrophobicity and antibacterial properties against S. mutans. Contact angle measurements were employed to assess the enhanced water repellency resulting from the quaternization process, while X-ray photoelectron spectroscopy (XPS) analysis was performed to characterize the modified coating surfaces. Bacterial culture experiments were conducted to confirm the reduction in bacterial activity, as indicated by colony counts. Fluorescent and scanning electron microscopy images were utilized to investigate the extent of bacterial coverage on the surfaces and to explore evidence of membrane damage to bacterial cells. The ultimate goal is to clarify the underlying mechanism that makes the antibacterial coating effective and to establish a foundation for its potential utilization in clinically preventing peri-implantitis.

### 2. Materials and Methods

The sample preparation begins by depositing a layer of SiCN, 100 nm in thickness, on a silicon wafer through the use of Plasma Enhanced Chemical Vapor Deposition (PECVD) at a pressure of 900 mTorr, utilizing a processing gas mixture of silane, methane, helium, and ammonia. The concentration of nitrogen in the SiCN layer was varied through adjustments in the flow rate of ammonia and had previously been analyzed using XPS analysis [45]. After the SiCN layer was applied, the samples were cut into 1 cm squares and rinsed with acetone and IPA. The nitrogen atoms on the SiCN surface were then converted to quaternary nitrogen by immersing the samples in a solution of acetonitrile and allyl bromide for one hour, through a process known as the Menschutkin reaction. Following quaternization, the samples were rinsed with isopropanol and de-ionized water to remove any excess solvent and reagent.

A sessile contact angle measurement was used to reveal the surface wettability of the samples. A 3 μL droplet of DI water was dropped on the surface by a syringe, and an image was captured by a microscopic camera with a cold backlit light source to prevent heating up the sample and the water. Analysis using the Young-Laplace equation was applied to the images to calculate the fitted contact angle. The contact angle data for each individual sample were determined as the average of five measurements. The chemical composition of the deposited films was studied using X-ray Photoelectron Spectroscopy (XPS) with an ESCALAB 250Xi instrument (Thermo Fisher Scientific, Pittsburgh, PA, USA) equipped with a monochromatic aluminum anode as the X-ray source. High-resolution scans for detailed peak analysis were performed at an electron pass energy of 20 eV and an energy step size of 0.1 eV, with a scanning range focusing on the nitrogen 1 s region. To better target the quaternized nitrogen atoms on the surface itself, scans were acquired at 0° and 45° tilting with respect to the normal. New spectra were also acquired after a gentle 300 s sputtering with an Ar cluster and then with 500 eV Ar ions to remove a layer of atoms on the surface and validate the location of the quaternized nitrogen atoms.

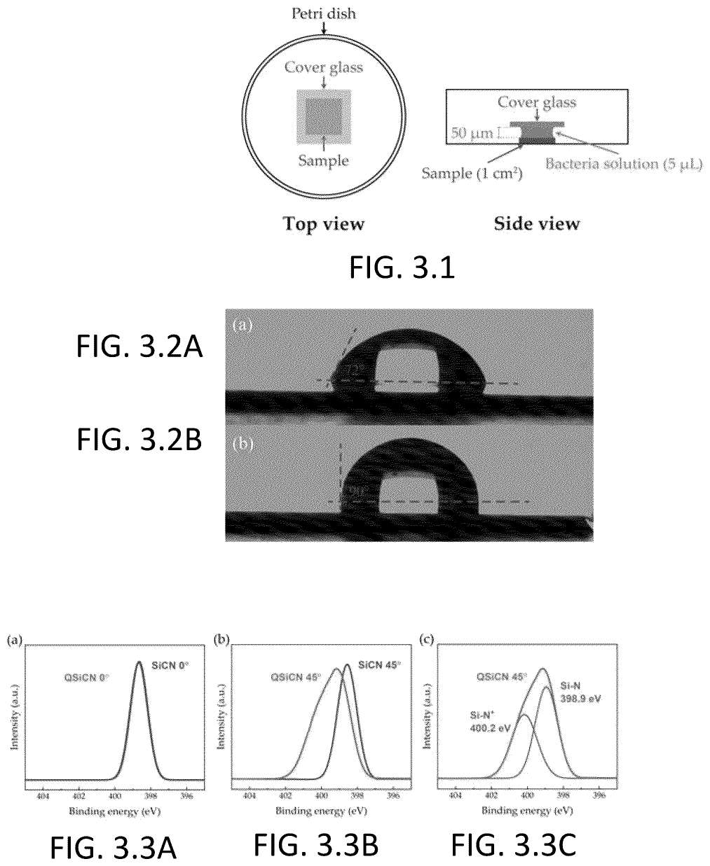

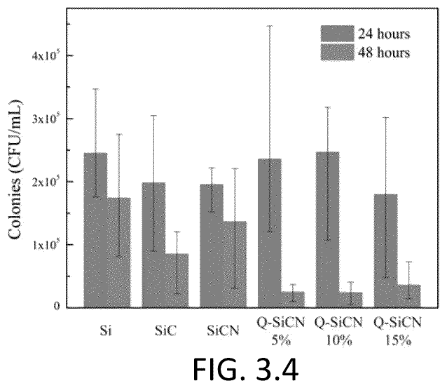

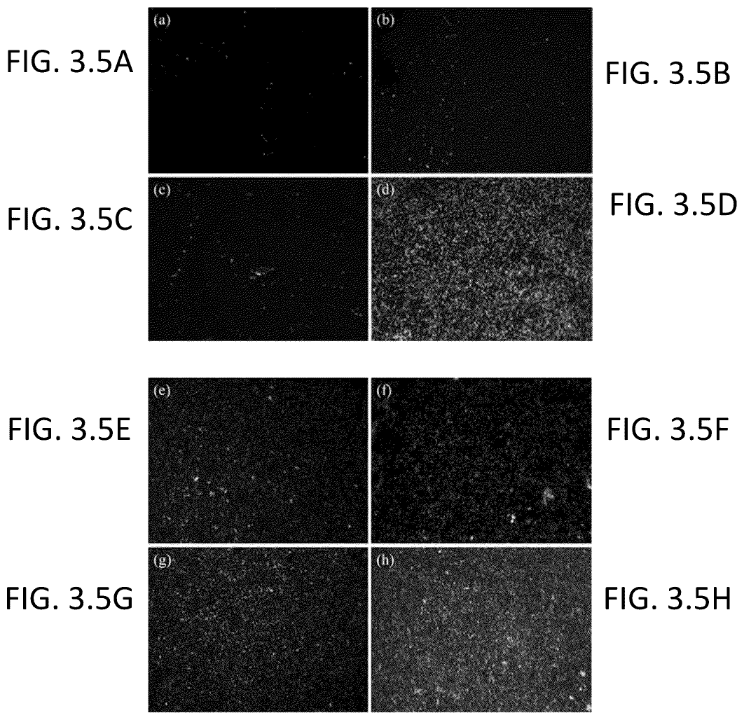

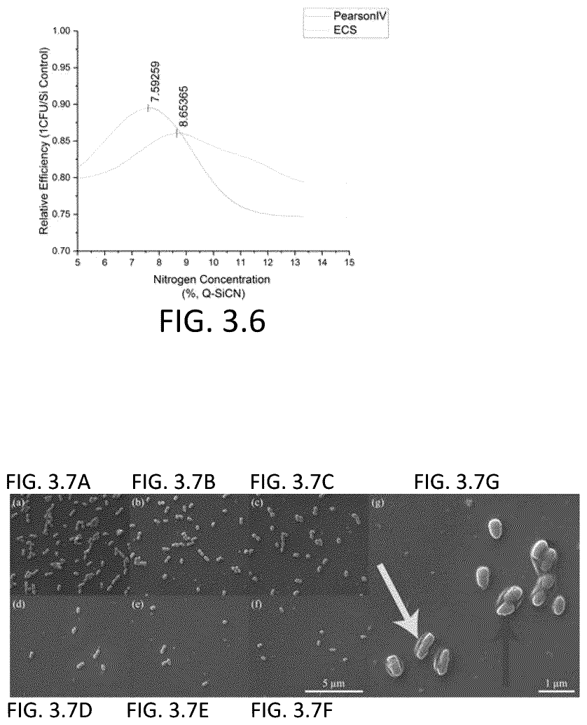

The bacterial culture was prepared by thawing and centrifuging a frozen stock of S. mutans to obtain pellets. These pellets were resuspended in a liquid growth media of Brain Heart Infusion broth (Himedia, Mumbai, India). The bacterial solution was allowed to incubate for 24 h at 37° C. in an incubator before being diluted to an optical density of 650 under a 650 nm wavelength using a spectrophotometer. The resulting solution contained approximately 107 colony-forming units per milliliter (CFU/mL) of bacteria. Before growing live bacteria, 6 (six) replicates of each condition-Si, SiCN, and QSiCN samples with 5, 10, and 15% nitrogen content-were decontaminated by rinsing and soaking in an ethanol bath for 20 min. A set of SiC samples was also added to the experiment as a comparison. Each sample was then placed in a separate sterile petri dish. Subsequently, the bacteria solution with 107 CFU/mL of S. mutans was applied onto the surface of the Si, SiC, SiCN, or QSiCN substrates using a micro-pipette, and this was followed by covering the sample surface from the top with another sterile cover glass slide. The gravitational force created by the glass slide allowed the bacteria solution to spread evenly up to the edge of the sample. In this case, the solution would not extend beyond the edge of the sample due to its surface tension (FIG. 3.1). Thus, the thickness of the biofilm was controlled by the volume of the bacteria solution (5 μL), since the area of the sample was the same (1 cm²). The whole container was then incubated at 37° C. for 24 and 48 h. Subsequently, the content of the container was transferred to a 50 mL falcon tube that contained 5 mL of BHI solution. The falcon tube was vortexed to peel off the biofilm and disperse the bacteria evenly in the solution. The resulting solution was then serially diluted with 10 and 100 fold dilution by BHI medium on a 24-well sterile plate. Next, 100 mL of the solution was dropped on a BHI agar plate and spread with an L-shaped plastic cell spreader, followed by incubation at 37° C. for 48 h. The colonies on the plates were then counted, multiplied back to the unit of CFU/mL and recorded for each sample accordingly.

For the antibacterial activity analysis, three samples of each of the SiCN samples with 5%, 10%, and 15% nitrogen content and a Si control group were placed in a sterilized 24-well plate and sterilized using ethanol. The samples were then rinsed three times with a solution of 1× phosphate-buffered saline (PBS). A total of 50 μL of 107 CFU/mL standardized bacterial inoculum and 1 mL of BHI broth culture media were added to the plate, covering up the samples. The plate was placed in a shaking incubator set at 37° C. and 75 rpm for 90 min to allow the bacteria to initially adhere to the samples in the form of biofilms. The supernatant was discarded, and the fresh broth was added to the plate, which was incubated for an additional 3 and 7 days to allow the biofilms to develop. After the designated time period, the samples were carefully rinsed with PBS and treated with formaldehyde for 15 min. The effectiveness of the Si and QSiCN samples in inhibiting bacterial growth was tested using a live/dead staining kit (Live/Dead BacLight™, Invitrogen). They were rinsed again with PBS and incubated for an additional 30 min at 37° C. in a dark box with the staining kit, which included a dye called SYRO® 9, which is used to stain living bacteria and allows for the determination of the number of live bacteria present. The samples were then inspected using a fluorescence microscope, and the images were captured to analyze the coverage of live bacteria on the surface of the samples.

For SEM surface analysis (FEI NOVA NanoSEM 430, FEI Company, Hillsboro, OR, USA), a set of samples with biofilm was separated before staining in the last step. A primary fixative solution and buffer solution were prepared by mixing sucrose, sodium cacodylate, glutaraldehyde, and deionized water. The samples were transferred to a new 24-well plate, and the bacteria were fixed by the primary fixative for 45 min. Subsequently, the samples were cleaned with ethanol and coated with 10 nm gold/platinum before imaging.

### 3. Results and Discussion

The behavior of a water droplet on the surface of a SiCN substrate before and after the quaternization process is displayed as sessile contact angle images in FIG. 3.2A and (b). The decrease in the contact angle on the quaternized surface compared to the untreated surface suggests a successful quaternization process, resulting in an increased hydrophobicity. This enhanced hydrophobicity can be attributed to the presence of extended allyl group chains originating from the surface, resulting from the Menshutkin reaction that converts tertiary nitrogen atoms into quaternary nitrogen atoms. For detailed quantitative information, Table 1 provides the specific average contact angles and standard deviations of Si, SiCN, and QSiCN substrates. Notably, the QSiCN surfaces exhibit contact angles that are 15° to 17° higher than those of the silicon surface, indicating a significant increase in water repellency. Moreover, the differences in contact angles between QSiCN substrates with varying nitrogen contents are minimal, with variances of less than 2°. This suggests that the nitrogen content in SiCN has a negligible influence on the wettability of the QSiCN surfaces.

TABLE 1
Sessile contact angle of Si, SiCN and quaternized
SiCN substrate with various nitrogen contents.

| Sample | Contact Angle (°) |
|---|---|
| Si | 72 ± 2 |
| SiCN with 5% nitrogen content | 75 ± 1 |
| Quaternized SiCN with 5% nitrogen | 90 ± 1 |
| content | |
| Quaternized SiCN with 10% nitrogen | 88 ± 2 |
| content | |
| Quaternized SiCN with 15% nitrogen | 87 ± 1 |
| content | |

The high-resolution XPS survey scans for the nitrogen 1 s spectra of the SiCN and QSiCN surfaces with a normal angle are shown in FIG. 3.3A. Both SiCN and QSiCN show an identical Si—N main peak at 398.6 eV, indicating no significant differences at a higher X-ray penetration depth. Subsequently, the samples were tilted at 45° with respect to the normal, which reduces the X-ray penetration depth and promotes the signals from the bonding of the surface layer atoms, as shown in FIG. 3.3B. A detailed peak separation for the QSiCN spectra is further shown in FIG. 3.3C. The tilted QSiCN surface spectra reveal a main peak corresponding to Si—N bonds located at 398.9 eV and a satellite peak of the quaternized nitrogen (N+) bound to the silicon at 400.2 eV. This proved the existence of the quaternized nitrogen on the surface of the QSiCN coating and the success of the quaternization process.

The results of the bacteria culture with S. mutans, shown in FIG. 3.4, demonstrate the antibacterial efficacy of the QSiCN surfaces. As a control group, SiC substrates were included, since our previous research established their antibacterial properties. SiCN substrates without quaternization were also included to compare the effects before and after the quaternization process. Three replicates were used for each sample condition, and two sets of incubation times, 24 and 48 h, were employed. To eliminate the possibility of sample contamination by other microorganisms, a blank group with only BHI medium was included as a reference for each condition. During the initial 24 h incubation period, no significant difference in colony count was observed among Si, SiC, SiCN, and any of the QSiCN samples. This phenomenon could be attributed to the resilience of the bacteria, which were freshly cultured 24 h before the experiment and adapted to the new environments. However, after 48 h of incubation, the SiC sample exhibited ap-proximately 50% fewer colonies compared to the Si sample. Notably, all three QSiCN samples with varying nitrogen contents showed significantly fewer colonies, with an over 80% reduction compared to the Si blank control. These findings highlight the re-markable antibacterial effect brought about by the quaternized surface, confirming the antibacterial ability of the SiCN substrates with quaternization. Furthermore, the anti-bacterial efficiency of the QSiCN samples remains largely unaffected by the three different nitrogen concentrations in the coating, indicating that the nitrogen content has a minimal impact on the bactericidal property of the QSiCN surfaces. This suggests that the quaternization process confers significant antibacterial activity to the SiCN surfaces, regardless of the nitrogen concentration in the coating.

The results obtained from the staining assay reveal a noteworthy decrease in the population of viable bacteria on the QSiCN samples as compared to the control group of pure silicon substrates. This is evident from the fluorescence images depicted in FIG. 3.5, where live bacteria are marked in green against a dark background. The coverage of live bacteria on the QSiCN samples is significantly reduced after 3 and 7 days of culture, indicating a bactericidal effect against S. mutans. In comparison to the Si sample, the QSiCN samples exhibit visibly less coverage of bacteria on the surface even after 3 days of incubation (FIG. 3.5A). Even after 7 days of incubation, while the bacteria on the Si sample reach near-saturation, the QSiCN samples still demonstrate a distinctly reduced bacterial coverage (FIG. 3.5B). No significant differences were observed with regard to nitrogen concentrations on the QSiCN surfaces.

The Nitrogen % analysis using classical Machine Learning techniques proved un-successful due to the extensive variation observed in the dataset, emphasizing the need for a larger number of data points. Nonetheless, a promising breakthrough was achieved by determining the relative efficiency of Q-SiCN in comparison to Si. This was accomplished by employing the formula 1−(CFUexp/CFUcontrol) and integrating it with dose-response equations. Two mathematical equations, namely the Pearson IV and Edgeworth-Cramer Peak Function (ECS), were adapted from chromatography methods and applied to the dataset [46,47]. Although the fit was relatively weak, the results were deemed sufficient for preliminary data-analysis purposes. Refer to the accompanying FIG. 3.6 for visual representation. Based on the available data, the optimal concentration range was estimated to lie between 7.6% and 8.6%. To improve future sample collection, it is recommended that one follow a geometric progression of concentrations, including 1 wt %, 2 wt %, 4 wt %, 8 wt %, and 16 wt %. Further investigations involving a more ex-tensive dataset could facilitate the utilization of machine-learning methods, thereby enhancing the reliability of the findings. This approach holds promise for future research endeavors.

In order to investigate the underlying factors responsible for the enhanced anti-bacterial properties of the QSiCN surfaces, SEM images were obtained after fixing the bacterial cells on surfaces that were incubated for 3 days and 7 days under different conditions. Bacterial coverage on non-quaternized surfaces of Si, SiC, and SiCN (FIG. 3.7A-C) demonstrates significantly more bacteria compared to the quaternized surfaces (FIG. 3.7D-F). Upon applying a higher magnification, an intriguing observation was made in FIG. 3.7G, which depicts the 5% nitrogen-containing QSiCN surface. The SEM image revealed a ring-shaped pattern in the surrounding area, along with an irregular outline of the bacterial cell, indicating ruptures in the bacterial membrane. This suggests that the bacterial cells on the QSiCN surface underwent membrane damage, leading to cell termination on the surface of the substrate [15,30,48]. This finding pro-vides valuable insight into the potential mechanism underlying the enhanced antibac-terial effect of the QSiCN surfaces.

### 4. Conclusions

The results of this study demonstrate the successful quaternization of SiCN surfaces, resulting in an increased hydrophobicity and significant antibacterial properties against S. mutans. The contact angle measurements revealed that the QSiCN surfaces exhibited higher contact angles compared to untreated Si surfaces, indicating an increased water repellency. The XPS analysis indicated successfully quaternized nitrogen atoms on the SiCN surface. The antibacterial efficacy of the QSiCN surfaces was confirmed through bacterial culture experiments, demonstrating significant reductions in colony counts compared to control groups. The staining assay further revealed a reduced bacterial coverage on the QSiCN surfaces after 3 and 7 days of culture, indicating a bactericidal effect. SEM images provided insights into the potential mechanism underlying the enhanced antibacterial effect, suggesting membrane damage of the bacterial cells on the QSiCN surfaces. Overall, these findings highlight the potential of QSiCN surfaces for applications in antibacterial coatings, with further investigations warranted to fully elucidate the underlying mechanism.

### REFERENCES FOR EXAMPLE 3

1. Howe, M. S.; Keys, W.; Richards, D. Long-term (10-year) dental implant survival: A systematic review and sensitivity me-ta-analysis. J. Dent. 2019, 84, 9-21. https://doi.org/10.1016/j.jdent.2019.03.008.
2. Charalampakis, G.; Leonhardt, A.; Rabe, P.; Dahlen, G. Clinical and microbiological characteristics of peri-implantitis cases: A retrospective multicentre study. Clin. Oral Implant. Res. 2012, 23, 1045-1054. https://doi.org/10.1111/j.1600-0501.2011.02258.x.
3. Ivanovski, S.; Bartold, P. M.; Huang, Y. S. The role of foreign body response in peri-implantitis: What is the evidence? Perio-dontology 2000 2022, 90, 176-185. https://doi.org/10.1111/prd.12456.
4. Derks, J.; Tomasi, C. Peri-implant health and disease. A systematic review of current epidemiology. J. Clin. Periodontol. 2015, 42 (Suppl. S16), S158-S171. https://doi.org/10.1111/jcpe.12334
5. Klinge, B.; Hultin, M.; Berglundh, T. Peri-implantitis. Dent. Clin. 2005, 49, 661-676.
6. Algraffee, H.; Borumandi, F.; Cascarini, L. Peri-implantitis. Br. J. Oral Maxillofac. Surg. 2012, 50, 689-694.
7. Mombelli, A.; Müller, N.; Cionca, N. The epidemiology of peri-implantitis. Clin. Oral Implant. Res. 2012, 23, 67-76.
8. Smeets, R.; Henningsen, A.; Jung, O.; Heiland, M.; Hammächer, C.; Stein, J. M. Definition, etiology, prevention and treatment of peri-implantitis-A review. Head Face Med. 2014, 10, 34.
9. Leonhardt, Å.; Dahlén, G.; Renvert, S. Five-year clinical, microbiological, and radiological outcome following treatment of peri-implantitis in man. J. Periodontol. 2003, 74, 1415-1422.
10. Renvert, S.; Roos-Jansåker, A. M.; Claffey, N. Non-surgical treatment of peri-implant mucositis and peri-implantitis: A liter-ature review. J. Clin. Periodontol. 2008, 35, 305-315.
11. Heitz-Mayfield, L. J.; Mombelli, A. The therapy of peri-implantitis: A systematic review. Int. J. Oral Maxillofac. Implant. 2014, 29, 325-345.
12. Kortvelyessy, G.; Tarjanyi, T.; Barath, Z. L.; Minarovits, J.; Toth, Z. Bioactive coatings for dental implants: A review of al-ternative strategies to prevent peri-implantitis induced by anaerobic bacteria. Anaerobe 2021, 70, 102404. https://doi.org/10.1016/j.anaerobe.2021.102404.
13 Faveri, M.; Figueiredo, L. C.; Shibli, J. A.; Perez-Chaparro, P. J.; Feres, M. Microbiological diversity of peri-implantitis biofilms. Adv. Exp. Med. Biol. 2015, 830, 85-96. https://doi.org/10.1007/978-3-319-11038-7_5.
14. Jennes, M.-E.; Naumann, M.; Peroz, S.; Beuer, F.; Schmidt, F. Antibacterial effects of modified implant abutment surfaces for the prevention of peri-implantitis-A systematic review. Antibiotics 2021, 10, 1350.
15. Chen, Z.; Wang, Z.; Qiu, W.; Fang, F. Overview of Antibacterial Strategies of Dental Implant Materials for the Prevention of Peri-Implantitis. Bioconjug. Chem. 2021, 32, 627-638. https://doi.org/10.1021/acs.bioconjchem.1c00129.
16. de Avila, E. D.; van Oirschot, B. A.; van den Beucken, J. Biomaterial-based possibilities for managing peri-implantitis. J. Per-iodontal Res. 2020, 55, 165-173. https://doi.org/10.1111/jre.12707.
17. Harris, L. G.; Tosatti, S.; Wieland, M.; Textor, M.; Richards, R. G. Staphylococcus aureus adhesion to titanium oxide surfaces coated with non-functionalized and peptide-functionalized poly(L-lysine)-grafted-poly(ethylene glycol) copolymers. Bio-materials 2004, 25, 4135-4148. https://doi.org/10.1016/j.biomaterials.2003.11.033.
18 Nishida, M.; Nakaji-Hirabayashi, T.; Kitano, H.; Saruwatari, Y.; Matsuoka, K. Titanium alloy modified with anti-biofouling zwitterionic polymer to facilitate formation of bio-mineral layer. Colloids Surf. B Biointerfaces 2017, 152, 302-310.
19. Calderon, P. D. S.; Rocha, F. R. G.; Xia, X.; Camargo, S. E. A.; Pascoal, A. L. B.; Chiu, C. W.; Ren, F.; Ghivizzani, S.; Esquiv-el-Upshaw, J. F. Effect of Silicon Carbide Coating on Osteoblast Mineralization of Anodized Titanium Surfaces. J. Funct. Biomater. 2022, 13, 247. https://doi.org/10.3390/jfb13040247.
20. Hsu, S. M.; Ren, F.; Chen, Z.; Kim, M.; Fares, C.; Clark, A. E.; Neal, D.; Esquivel-Upshaw, J. F. Novel Coating to Minimize Corrosion of Glass-Ceramics for Dental Applications. Materials 2020, 13, 1215. https://doi.org/10.3390/ma13051215.
21. Fares, C.; Hsu, S. M.; Xian, M.; Xia, X.; Ren, F.; Mecholsky, J. J., Jr.; Gonzaga, L.; Esquivel-Upshaw, J. Demonstration of a SiC Protective Coating for Titanium Implants. Materials 2020, 13, 3321. https://doi.org/10.3390/ma13153321.
22. Martins, A. F.; Facchi, S. P.; Follmann, H. D.; Pereira, A. G.; Rubira, A. F.; Muniz, E. C. Antimicrobial activity of chitosan de-rivatives containing N-quaternized moieties in its backbone: A review. Int. J. Mol. Sci. 2014, 15, 20800-20832.
23 Ng, V. W. L.; Tan, J. P. K.; Leong, J.; Voo, Z. X.; Hedrick, J. L.; Yang, Y. Y. Antimicrobial polycarbonates: Investigating the impact of nitrogen-containing heterocycles as quaternizing agents. Macromolecules 2014, 47, 1285-1291.
24. Park, D.; Finlay, J. A.; Ward, R. J.; Weinman, C. J.; Krishnan, S.; Paik, M.; Sohn, K. E.; Callow, M. E.; Callow, J. A.; Handlin, D. L. Antimicrobial behavior of semifluorinated-quaternized triblock copolymers against airborne and marine microorganisms. ACS Appl. Mater. Interfaces 2010, 2, 703-711.
25. Semenov, V.; Voloshina, A.; Toroptzova, E.; Kulik, N.; Zobov, V.; Giniyatullin, R. K.; Mikhailov, A.; Nikolaev, A.; Akamsin, V.; Reznik, V. Antibacterial and antifungal activity of acyclic and macrocyclic uracil derivatives with quaternized nitrogen atoms in spacers. Eur. J. Med. Chem. 2006, 41, 1093-1101.
26 Piras, A. M.; Esin, S.; Benedetti, A.; Maisetta, G.; Fabiano, A.; Zambito, Y.; Batoni, G. Antibacterial, Antibiofilm, and Anti-adhesive Properties of Different Quaternized Chitosan Derivatives. Int. J. Mol. Sci. 2019, 20, 6297. https://doi.org/10.3390/ijms20246297.
27. Wassmann, M.; Winkel, A.; Haak, K.; Dempwolf, W.; Stiesch, M.; Menzel, H. Influence of quaternization of ammonium on antibacterial activity and cytocompatibility of thin copolymer layers on titanium. J. Biomater. Sci. Polym. Ed. 2016, 27, 1507-1519. https://doi.org/10.1080/09205063.2016.1214001.
28. Peng, Z. X.; Tu, B.; Shen, Y.; Du, L.; Wang, L.; Guo, S. R.; Tang, T. T. Quaternized chitosan inhibits icaA transcription and biofilm formation by Staphylococcus on a titanium surface. Antimicrob. Agents Chemother. 2011, 55, 860-866. https://doi.org/10.1128/AAC.01005-10.
29. Oosterhof, J. J.; Buijssen, K. J.; Busscher, H. J.; van der Laan, B. F.; van der Mei, H. C. Effects of quaternary ammonium silane coatings on mixed fungal and bacterial biofilms on tracheoesophageal shunt prostheses. Appl. Environ. Microbiol. 2006, 72, 3673-3677. https://doi.org/10.1128/AEM.72.5.3673-3677.2006.
30 Haldar, J.; Kondaiah, P.; Bhattacharya, S. Synthesis and antibacterial properties of novel hydrolyzable cationic amphiphiles. Incorporation of multiple head groups leads to impressive antibacterial activity. J. Med. Chem. 2005, 48, 3823-3831. https://doi.org/10.1021/jm0491061.
31. Codling, C. E.; Maillard, J. Y.; Russell, A. D. Aspects of the antimicrobial mechanisms of action of a polyquaternium and an amidoamine. J. Antimicrob. Chemother. 2003, 51, 1153-1158. https://doi.org/10.1093/jac/dkg228.
32. Guan, Y.; Qian, L.; Xiao, H. Novel Anti-Microbial Host-Guest Complexes Based on Cationic?-Cyclodextrin Polymers and Triclosan/Butylparaben. Macromol. Rapid Commun. 2007, 28, 2244-2248. https://doi.org/10.1002/marc.200700505.
33. Timofeeva, L.; Kleshcheva, N. Antimicrobial polymers: Mechanism of action, factors of activity, and applications. Appl. Microbiol. Biotechnol. 2011, 89, 475-492. https://doi.org/10.1007/s00253-010-2920-9.
34. Xue, Y.; Xiao, H.; Zhang, Y. Antimicrobial polymeric materials with quaternary ammonium and phosphonium salts. Int. J. Mol. Sci. 2015, 16, 3626-3655. https://doi.org/10.3390/ijms16023626.
35. Han, A.; Tsoi, J. K. H.; Rodrigues, F. P.; Leprince, J. G.; Palin, W. M. Bacterial adhesion mechanisms on dental implant surfaces and the influencing factors. Int. J. Adhes. Adhes. 2016, 69, 58-71. https://doi.org/10.1016/j.ijadhadh.2016.03.022.
36 Nascimento, C.; Pita, M. S.; Santos Ede, S.; Monesi, N.; Pedrazzi, V.; Albuquerque Junior, R. F.; Ribeiro, R. F. Microbiome of titanium and zirconia dental implants abutments. Dent. Mater. 2016, 32, 93-101. https://doi.org/10.1016/j.dental.2015.10.014.
37. Meza-Siccha, A. S.; Aguilar-Luis, M. A.; Silva-Caso, W.; Mazulis, F.; Barragan-Salazar, C.; Del Valle-Mendoza, J. In Vitro Evaluation of Bacterial Adhesion and Bacterial Viability of Streptococcus mutans, Streptococcus sanguinis, and Porphyromonas gingivalis on the Abutment Surface of Titanium and Zirconium Dental Implants. Int. J. Dent. 2019, 2019, 4292976. https://doi.org/10.1155/2019/4292976.
38. Koo, H.; Xiao, J.; Klein, M. I.; Jeon, J. G. Exopolysaccharides produced by Streptococcus mutans glucosyltransferases modulate the establishment of microcolonies within multispecies biofilms. J. Bacteriol. 2010, 192, 3024-3032. https://doi.org/10.1128/JB.01649-09.
39. Beighton, D. The complex oral microflora of high-risk individuals and groups and its role in the caries process. Community Dent. Oral Epidemiol. 2005, 33, 248-255. https://doi.org/10.1111/j.1600-0528.2005.00232.x.
40. Bowen, W. H. Do we need to be concerned about dental caries in the coming millennium? Crit. Rev. Oral Biol. Med. 2002, 13, 126-131. https://doi.org/10.1177/154411130201300203.
41. Kumar, P. S.; Mason, M. R.; Brooker, M. R.; O'Brien, K. Pyrosequencing reveals unique microbial signatures associated with healthy and failing dental implants. J. Clin. Periodontol. 2012, 39, 425-433. https://doi.org/10.1111/j.1600-051X.2012.01856.x.
42. Laosuwan, K.; Epasinghe, D. J.; Wu, Z.; Leung, W. K.; Green, D. W.; Jung, H. S. Comparison of biofilm formation and migration of Streptococcus mutans on tooth roots and titanium miniscrews. Clin. Exp. Dent. Res. 2018, 4, 40-47. https://doi.org/10.1002/cre2.101.
43. Geremias, T. C.; Montero, J. F. D.; Magini, R. S.; Schuldt Filho, G.; de Magalhaes, E. B., Jr.; Bianchini, M. A. Biofilm Analysis of Retrieved Dental Implants after Different Peri-Implantitis Treatments. Case Rep. Dent. 2017, 2017, 8562050. https://doi.org/10.1155/2017/8562050.
44. Lemos, J. A.; Palmer, S. R.; Zeng, L.; Wen, Z. T.; Kajfasz, J. K.; Freires, I. A.; Abranches, J.; Brady, L. J. The Biology of Streptococcus mutans. Microbiol. Spectr. 2019, 7, 1. https://doi.org/10.1128/microbiolspec.GPP3-0051-2018.
45 Xia, X.; Chiang, C.-C.; Gopalakrishnan, S. K.; Kulkarni, A. V.; Ren, F.; Ziegler, K. J.; Esquivel-Upshaw, J. Properties of SiCN Films Relevant to Dental Implant Applications. J. Mater. 2023, 16, 5318.
46 Di Marco, V. B.; Bombi, G. G. Mathematical functions for the representation of chromatographic peaks. J. Chromatogr. A 2001, 931, 1-30. https://doi.org/10.1016/s0021-9673 (01) 01136-0.
47. Felinger, A. 5 Peak shape analysis. Data Handl. Sci. Technol. 1998, 21, 97-124. https://doi.org/10.1016/s0922-3487 (98) 80024-5.
48. Rawlinson, L. A.; Ryan, S. M.; Mantovani, G.; Syrett, J. A.; Haddleton, D. M.; Brayden, D. J. Antibacterial effects of poly(2-(dimethylamino ethyl) methacrylate) against selected gram-positive and gram-negative bacteria. Biomacromolecules 2010, 11, 443-453. https://doi.org/10.1021/bm901166y.

What is claimed is:

1. A medical apparatus, comprising a structure having a silicon carbonitride (SiCN) layer or a quaternized SiCN layer on the outside surface of the structure.

2. The apparatus of claim 1, wherein the structure is a dental implant, crown, bridge, filling, veneer, inlay, onlay, endodontic device, or orthodontic bracket.

3. The apparatus of claim 1, wherein the structure is a made of a material comprising porcelain, a ceramic, or a resin, wherein the SiCN layer or a quaternized SiCN layer is on an outside surface of the structure.

4. The apparatus of claim 3, wherein the porcelain is a porcelain layer that is part of a veneer for a tooth.

5. The apparatus of claim 1, wherein the structure includes a titanium layer, wherein the SiCN layer or a quaternized SiCN layer is disposed on the titanium layer, wherein the SiCN layer or a quaternized SiCN layer is on an outside surface of the structure.

6. The apparatus of claim 1, wherein the SiCN layer or a quaternized SiCN layer has a thickness of about 10-20 nm.

7. The apparatus of claim 1, wherein the structure has the quaternized SiCN layer, wherein the quaternized SiCN layer has a nitrogen content of about 0.5 to 15%.

8. The apparatus of claim 1, wherein the structure has the quaternized SiCN layer, wherein the structure has a Sessile contact angle of greater than 85°.

9. The apparatus of claim 1, wherein the structure has the quaternized SiCN layer, wherein the quaternized SiCN layer comprises an alkyl halide derivative, wherein the alkyl halide derivative is a derivative of a C1-C6 alkyl halide.

10. The apparatus of claim 9, wherein the alkyl halide is a quaternary ammonium moiety.

11. A method for forming a silicon carbonitride (SiCN) layer on an apparatus, comprising:
mixing NH₃ gas, SiH₄ gas, and CH₄ gas in a chamber, wherein the chamber includes the apparatus, and
forming a silicon carbonitride (SiCN) layer on a structure of the apparatus.

12. The method of claim 11, wherein the NH₃ flow rates is about 2 to 8 sccm, wherein the SiH₄ flow rates of 200 to 300 sccm, and wherein the CH₄ flow rate is about 100 to 200 sccm.

13. The method of claim 11, wherein forming is performed using plasma-enhanced chemical vapor deposition (PECVD).

14. The method of claim 11, wherein the SiCN layer formed has a thickness of about 10-20 nm.

15. The method of claim 11, wherein the structure is a dental implant, crown, bridge, filling, veneer, inlay, onlay, endodontic device, or orthodontic bracket.

16. The method of any one of claims 11 to 15, wherein the structure is a made of a material comprising porcelain, a ceramic, or a resin, wherein the SiCN layer is on an outside surface of the structure.

17. The method of claim 11, further comprising: quaternizing the SiCN layer to form a quaternized SiCN layer.

18. The method of claim 17, wherein quaternizing includes reacting the SICN layer with an allyl halide to quaternize the SiCN layer.

19. The method of claim 18, wherein the allyl halide comprises allyl bromide.
